(19) United States
(12) Patent Application Publication
(10) Pub. No.: US 2024/0417955 A1
(43) Pub. Date: Dec. 19, 2024

(54) PROCESSING DEVICE, PROCESSING METHOD, AND PROGRAM

(71) Applicant: NEC Corporation, Minato-ku, Tokyo (JP)

(72) Inventor: Mineto SATOH, Tokyo (JP)

(73) Assignee: NEC Corporation, Minato-ku, Tokyo (JP)

(21) Appl. No.: 18/704,508

(22) PCT Filed: Nov. 11, 2021
(86) PCT No.: PCT/JP2021/041549

§ 371 Date: Apr. 25, 2024

(51) Int. Cl. E02F 9/20; B25J 9/16; E02F 9/24; E02F 9/26

(52) U.S. Cl. CPC E02F 9/2033; B25J 9/1666; E02F 9/24; E02F 9/26

(57) ABSTRACT

A processing device determines whether or not a control target has entered an area other than an area that the control target is allowed to enter in an environment of a range including at least a part of the control target. The processing device executes a predetermined process when it is determined that the control target has entered an area other than the area that the control target is allowed to enter.

### TECHNICAL FIELD

The present invention relates to a processing device, a processing method, and a program.

### BACKGROUND ART

In robots, transport vehicles, construction machines, and the like with arms, there are various control technologies for controlling control targets. Patent Document 1 discloses technology pertaining to control for decelerating or stopping an operation of a shovel when the shovel that is a control target enters a prohibited area set for an obstacle.

### PRIOR ART DOCUMENTS

### Patent Document

[Patent Document 1]

PCT International Publication No. WO 2019/189203

### SUMMARY OF INVENTION

### Technical Problem

However, when a control target such as a shovel enters a prohibited area set for an obstacle and an obstacle is misrecognized in a control process of decelerating or stopping an operation of the control target, it is difficult to precisely control the control target. Therefore, when the technology disclosed in Patent Document 1 is used, it is not necessarily possible to precisely control the control target in a situation in which the obstacle is misrecognized.

Therefore, there is a need for technology for precisely controlling a control target.

An example of an objective of the present invention is to provide a processing device, a processing method, and a program for solving the problems described above.

### Solution to Problem

As an aspect of the present invention, there is provided a processing device including: a determination means configured to determine whether or not a control target has entered an area other than an area that the control target is allowed to enter in an environment of a range including at least a part of the control target having a movable unit; and a processing means configured to execute a predetermined process when the determination means determines that the control target has entered an area other than the area that the control target is allowed to enter.

Moreover, as another aspect of the present invention, there is provided a processing method including: determining whether or not a control target has entered an area other than an area that the control target is allowed to enter in an environment of a range including at least a part of the control target having a movable unit; and executing a predetermined process when it is determined that the control target has entered an area other than the area that the control target is allowed to enter.

Moreover, as yet another aspect of the present invention, there is provided a recording medium recording a program for causing a computer to: determine whether or not a control target has entered an area other than an area that the control target is allowed to enter in an environment of a range including at least a part of the control target having a movable unit; and execute a predetermined process when it is determined that the control target has entered an area other than the area that the control target is allowed to enter.

### Advantageous Effects of Invention

In the processing device, processing method, and program according to the present invention, a process of precisely controlling a control target can be implemented.

### BRIEF DESCRIPTION OF DRAWINGS

FIG. 1 is a diagram showing an example of a configuration of a control system according to a first example embodiment.

FIG. 2 is a flowchart showing an example of a processing procedure performed by the control system according to the first example embodiment.

FIG. 3 is a diagram showing an example of a configuration of a control system according to a second example embodiment.

FIG. 4 is a flowchart showing an example of a processing procedure performed by the control system according to the second example embodiment.

FIG. 5 is a diagram showing an example of a configuration of a control system according to a third example embodiment.

FIG. 6 is a diagram showing an example of a configuration of a control system of a first application example.

FIG. 7 is a diagram for describing a specific example of a process of an information comparison unit according to the first application example.

FIG. 8 is a diagram for describing a process of a determination processing unit according to the first application example.

FIG. 9 is a diagram for describing a process of the determination processing unit according to the first application example.

FIG. 10 is a diagram showing an example of a configuration of a control system according to a second application example.

FIG. 11 is a diagram for describing a process of the determination processing unit according to the second application example.

FIG. 12 is a flowchart related to a process of the determination processing unit according to the second application example.

FIG. 13 is a diagram for describing processes of an information generation unit and a determination processing unit according to a third application example.

FIG. 14 is a diagram showing a minimum configuration of a processing device according to an example embodiment.

FIG. 15 is a flowchart showing an example of a processing procedure performed by the processing device having the minimum configuration according to the example embodiment.

FIG. 16 is a schematic block diagram showing a configuration of a computer according to at least one example embodiment.

### EXAMPLE EMBODIMENTS

Although example embodiments will be described hereinafter, these example embodiments do not limit inventions described in the claims.

In the following description and drawings of the example embodiments, unless otherwise described, the same reference signs denote the same things. Moreover, in the following description of the example embodiments, redundant description of similar configurations or operations may be omitted.

### First Example Embodiment

### (Configuration of Control System)

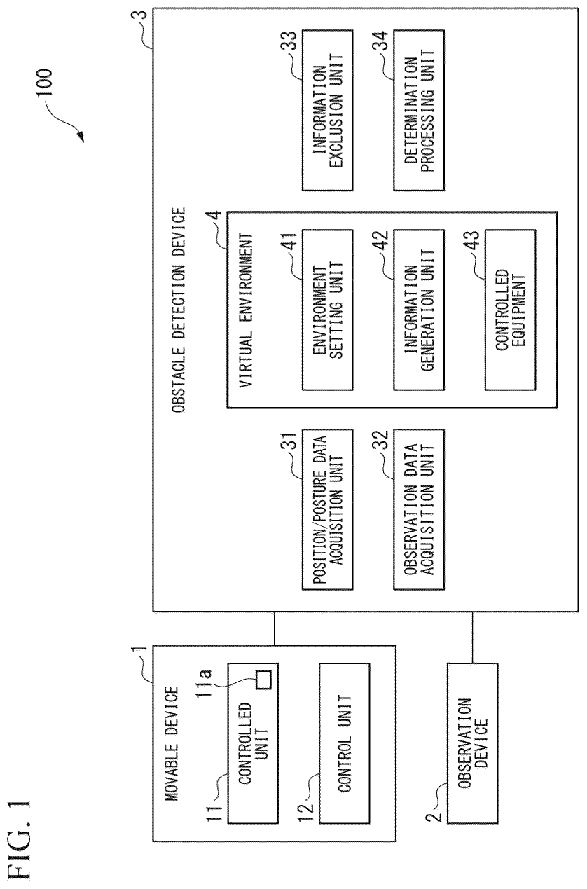

FIG. 1 is a diagram showing an example of a configuration of a control system 100 according to the first example embodiment. In the configuration shown in FIG. 1, the control system 100 includes a movable device 1, an observation device 2, and an obstacle detection device 3 (an example of a processing device). The control system 100 is a system in which a control unit 12 to be described below controls a controlled unit 11 having a movable unit 11a on the basis of information obtained from the observation device 2 in the movable device 1.

The movable device 1 includes a controlled unit 11 (an example of a control target) that is a target to be controlled, and a control unit 12 (an example of a control means) that controls the controlled unit 11.

The movable device 1 is, for example, a robot, a transport vehicle, or a construction machine with an arm or the like, but is not limited thereto. Examples of the construction machine with an arm include power shovels, backhoes, cranes, forklifts, and the like. In power shovels, backhoes, cranes, and forklifts, a housing portion for performing work such as an arm, a bucket, or a shovel is the controlled unit 11. The controlled unit 11 has a movable unit 11a. The movable unit 11a is, for example, an actuator. The control unit 12 controls the controlled unit 11. When the control unit 12 controls the controlled unit 11, the movable unit 11a of the controlled unit 11 operates.

The observation device 2 observes at least a space where the movable device 1 operates and outputs observation information of the observed space (an example of an actual measured value). The observation device 2 includes a camera that acquires image (RGB) or three-dimensional image (RGB-D) data for a movable range of the controlled unit 11, for example, such as a monocular camera, a compound eye camera, a monochrome camera, an RGB camera, a depth camera, or a time of flight (ToF) camera, a device such as a video camera, a device for optically measuring a distance to a target, for example, such as a light detection and ranging (LiDAR) sensor, or a device for performing measurement by radio waves, such as a radio detection and ranging (RADAR) sensor, and specific configurations of these devices are not limited in the present example embodiment. The observation device 2 may be a single device or a combination of a plurality of devices. Moreover, the observation device 2 acquires observation data for an observation area including at least the movable range of the controlled unit 11. Therefore, the observation data includes at least a part of the housing of the controlled unit 11. In other words, the observation data includes information about a surrounding environment such as an obstacle and information about the controlled unit 11 of the movable device 1 that is a control target. Here, an observation area of the observation device 2 is determined according to conditions such as an installation position and an installation direction (angle) when the observation device 2 is installed, and the performance and parameters specific to the observation device. The installation of the observation device 2 can be appropriately determined on the basis of a type and performance of the observation device 2, specifications (for example, a type, a size, a movable range, and the like) of the movable device 1 that is an observation target, work content, and a surrounding environment, and is not limited in the present invention. The type is a difference in the measurement method, and examples of the type include cameras, video cameras, LiDAR sensors, RADAR sensors, and the like. Examples of the performance include a field of view (FOV), a maximum measurement distance, resolution, and the like. The observation device 2 may be mounted on the movable device 1.

The obstacle detection device 3 includes a position/posture data acquisition unit 31 configured to acquire position/posture data of the controlled unit 11; an observation data acquisition unit 32 configured to acquire data of the observation device 2; an information exclusion unit 33 (an example of an exclusion means) configured to exclude information about the controlled unit 11 from the information obtained by the observation device 2 and output information after the exclusion; a determination processing unit 34 (an example of a determination means and an example of a processing means) configured to perform a determination process regarding the detection of an obstacle for the control system 100 on the basis of the information output from the information exclusion unit 33 and the information output from an information generation unit 42 to be described below in a virtual environment 4, and a virtual environment 4 simulating at least the controlled unit 11 in calculation.

In the obstacle detection device 3, the position/posture data acquisition unit 31 acquires position/posture data of the controlled unit 11. For example, when the movable device 1 is an arm provided in the robot, a so-called articulated robot arm, the position/posture data acquisition unit 31 acquires angle data of each joint of the arm as the position/posture data. This angle data can typically be acquired as an electrical signal by a sensor (for example, a rotary encoder) attached to an actuator that drives each joint. Moreover, for example, when the movable device 1 is a hydraulically controlled construction machine such as a backhoe, the position/posture data is acquired by a sensor attached to each movable unit 11a of the controlled unit 11 or the housing. Examples of the sensor include an inclination sensor, a gyro sensor, an acceleration sensor, an externally installed sensor such as an encoder, and a hydraulic sensor. The installation positions and number of sensors can be appropriately designed for each operation of the movable device 1 that is a detection target. Moreover, when the controlled unit 11 is moving according to a control process performed by the control unit 12, the position/posture data follows a change in the movable unit 11a of the controlled unit 11 over time. That is, information of an electrical signal acquired by the position/posture data acquisition unit 31 is information acquired in correspondence with an operation of the controlled unit 11 within a certain fixed error range and a certain fixed delay time range. Also, the temporal frequency (sampling rate) and spatial resolution (accuracy) of the signal are not particularly limited and can be appropriately determined in accordance with a size, characteristics, work content, or the like of the movable device 1.

In the obstacle detection device 3, the observation data acquisition unit 32 preferably acquires observation data output by the observation device 2. Also, the observation data acquisition unit 32 may acquire information as observation data from other means, for example, a sensor mounted on the movable device 1.

In the obstacle detection device 3, the virtual environment 4 is an environment simulating at least the controlled unit 11 in calculation. For example, the virtual environment 4 is an environment in which the dynamics of the controlled unit 11, a surrounding real environment, and the like are reproduced by executing a simulation using a simulator, a mathematical model, or the like, a so-called digital twin. However, the virtual environment 4 is not limited to the digital twin. There are two main points from which the controlled unit 11 is simulated. The first point is a shape of the controlled unit 11. The virtual environment 4 has a model in which a shape of the outline of the controlled unit 11, i.e., a size and three-dimensional shape thereof, is reproduced in the same shape of the outline of the actual controlled unit 11 or reproduced in a fixed error range or scale. The model of the controlled unit 11 can be constructed by a polygon (polygon) or an aggregate of polygons (i.e., a mesh) on the basis of, for example, a design drawing or CAD data of the controlled unit 11, image data of the controlled unit 11, or the like. Here, when the model of the controlled unit 11 is represented by a polygon, it is approximated in accordance with the shape, size, density, and the like of the polygon. However, the degree of approximation can be appropriately determined according to the size of the controlled unit 11 of the control target and the like. Also, when the model of the controlled unit 11 is represented by a polygon, because the model represents a three-dimensional shape, it is not necessary to reproduce the surface material, texture, pattern, or the like. Also, a method of constructing a model of the controlled unit 11 is not limited to the above-described method. The second point is the movement of the controlled unit 11, i.e., the movement (dynamics) of each movable unit 11a. The controlled unit 11 includes the movable unit 11a (actuator) to be controlled by at least one or more control units 12, and the model of the controlled unit 11 in the virtual environment 4 described in the first point of view of simulating the controlled unit 11 is the same as the actual controlled unit 11 or is reproduced in a fixed error range. It is only necessary to make a position and angular displacement similar to those of the actual movable unit 11a possible for the reproduction of the movement. It is not necessary to reproduce a mechanism and/or an internal structure of the movable unit 11a for the movement of the movable unit 11a. A method of configuring the movable unit 11a is not limited. Also, the virtual environment 4 may include a virtual observation means corresponding to the actual observation device 2 and an observation area that is an observation target. The virtual observation means will be described below.

The virtual environment 4 includes controlled equipment 43 (an example of a model of the controlled unit 11) configured to simulate the actual controlled unit 11 in the real environment; an environment setting unit 41 configured to set the controlled equipment 43 (and further set the observation means at the same position and/or posture as the observation device 2 when the information generation unit 42 is implemented by the virtual observation means corresponding to the observation device 2); and an information generation unit 42 configured to output information about the controlled unit 11 that has been simulated. In the virtual environment 4, the environment setting unit 41 arranges a model simulating the actual controlled unit 11 (including the movable unit 11a) in the controlled equipment 43 (i.e., sets the position and/or posture thereof) and sets the position and/or posture of the virtual observation device 2 by which the actual observation device 2 is simulated. In the three-dimensional area handled in the virtual environment 4, the model of the controlled unit 11 and the virtual observation device 2 are arranged so that their relationship is identical to a relative position or posture relationship between the actual controlled unit 11 and the actual observation device 2 or so that they are reproduced in a fixed error range or scale. That is, when either one of the model of the controlled unit 11 and the virtual observation device 2 is used as a reference for the position or posture, differences in a distance to the other and an angle are the same as those of an actual object or in a fixed error range or scale. Also, the scale here is assumed to be identical to the scale of the model of the controlled unit 11 described above. Preferably, the virtual environment 4 handles an area including a movable range of the actual controlled unit 11 and a model simulating the actual controlled unit 11 and the virtual observation device 2 are arranged in the same position or posture relationship as the actual controlled unit 11. Such a setting process regarding the position or posture relationship between the model of the controlled unit 11 and the observation device 2 is generally referred to as calibration. That is, the model of the controlled unit 11 and the virtual observation device 2 are set to a calibrated state. Also it is not essential to set a structure other than the model of the controlled unit 11 or a space boundary such as the ground. The movable unit 11a of the model of the controlled unit 11 is set on the basis of information about the actual controlled unit 11 acquired by the position/posture data acquisition unit 31. Preferably, the displacement, angle, or the like identical to that of the movable unit 11a of the actual controlled unit 11 is set or the displacement, angle, or the like is set in a fixed error range and therefore the three-dimensional shape of the model of the controlled unit 11 can be represented like the shape of the actual controlled unit 11. Moreover, the environment setting unit 41 sets the temporal displacement of the movable unit 11a of the actual controlled unit 11 on the basis of the information acquired by the position/posture data acquisition unit 31. Therefore, the model of the controlled unit 11 in the virtual environment 4 can move as in the movement of the actual controlled unit 11 within a certain fixed error or delay time range. Preferably, the model of the controlled unit 11 within the virtual environment 4 is synchronized (in synchronization) with the actual controlled unit 11.

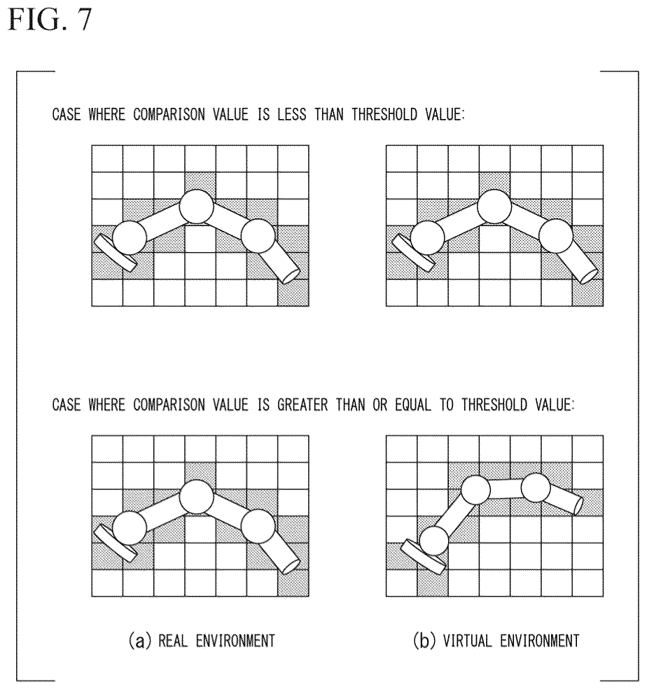

In the virtual environment 4, the information generation unit 42 generates at least information about the model within the virtual environment 4 in which the actual controlled unit 11 is simulated. As described above, because the model of the controlled unit 11 reproduces the shape and movement of the actual controlled unit 11, information corresponding to the shape and movement of the controlled unit 11 is generated by executing a simulation process using the model. Specifically, the generated information is an aggregate of three-dimensional positions occupied by the three-dimensional shape of the model of the controlled unit 11 at a certain time in the three-dimensional space handled in the virtual environment 4 or a time-series value of a three-dimensional position corresponding to the temporal displacement of the model of the controlled unit 11 (for example, a gray grid in the part of (b) of FIG. 7 to be described below). Preferably, the generated information is an aggregate of position information for each polygon representing the three-dimensional shape of the model of the controlled unit 11. Also, the spatial resolution of this position information depends on a size of the polygon representing the model of the controlled unit 11 and the like. Specifically, the resolution, for example, can be changed by performing an interpolation (up-sampling) process or a thinning-out (down-sampling) process between polygon position information items. Preferably, it is only necessary to change the resolution by increasing the spatial resolution, i.e., representing it with fine polygons or performing the up-sampling process, when the processing capability of a computer for performing a process in the information generation unit 42 is high and decreasing the resolution, i.e., down-sampling polygon position information, when the processing capability is low. As another implementation method of the information generation unit 42, a virtual observation means corresponding to the observation device 2 can be used. In this observation means, by installing the virtual observation device 2 in a virtual three-dimensional space corresponding to the position and/or posture of the actual observation device 2 set in the environment setting unit 41, observation data similar to that of the actual observation device 2, i.e., an image or a three-dimensional image, can be virtually acquired. In other words, the observation means includes a function of simulating the observation device 2 and simulating and outputting observation information observed from the position and/or posture where the observation device 2 is installed. The observation range of the observation device 2 includes at least a movable range of the controlled unit 11 and the observation information output by the observation means is information indicating a similar range. Therefore, the observation means outputs information (an example of an estimated value) obtained by observing a model simulating the controlled unit 11. That is, information of the shape indicated in the model of the controlled unit 11 and the position of the model of the controlled unit 11 in three-dimensional space and time-series information corresponding to the movement indicated in the model of the controlled unit 11 can be obtained. Preferably, it is only necessary for this virtual observation means to be an observation device having performance, i.e., an imaging range or resolution, similar to that of the observation device 2. Also, the virtual observation means may be appropriately adjusted in accordance with the processing capability of the computer for performing a process in the information generation unit 42 or the like. Moreover, the information generation unit 42 may generate information of something other than a portion corresponding to the model of the controlled unit 11. For example, the information generation unit 42 may generate information about a structure other than the model of the controlled unit 11 reproduced in the virtual environment 4, information about the boundary of a space such as the ground, or information dependent on the work performed by the movable device 1. The information dependent on the work is, for example, a target object for which the controlled unit 11 performs work, a work area, or the like when the movable device 1 is a robot arm or a construction machine.

In the obstacle detection device 3, the information exclusion unit 33 performs a process of excluding information on the basis of the information generated by the information generation unit 42 of the virtual environment 4 from the information acquired by the observation data acquisition unit 32. Specifically, a process of excluding (filtering or masking) the three-dimensional shape generated by the information generation unit 42 of the virtual environment 4 from the information acquired by the observation data acquisition unit 32, i.e., the observation information corresponding to the observation data output by the observation device 2 is performed. As described above, the observation information includes at least a portion of the controlled unit 11 and the information generated by the information generation unit 42 includes at least shape information of the model simulating the controlled unit 11. That is, in a process of excluding these two information items, the information exclusion unit 33 can output information in which the controlled unit 11 is excluded from the observation information, in other words, observation information in which the controlled unit 11 is not included. The observation information in which the controlled unit 11 is not included is, for example, other structures, and the like, and is defined as information (obstacle candidate information) including an area that the controlled unit 11 should not approach or enter, i.e., an obstacle itself and an area that becomes an obstacle to the controlled unit 11 in each example embodiment. Also, because the excluded area is an area output by the information generation unit 42, an area other than the controlled unit 11, i.e., an area where approach or entry is allowed depending on the work performed by the movable device 1, can also be included as described above. That is, the area where approach or entry is allowed is not included in the obstacle candidate information. Moreover, when the controlled unit 11 is in operation, obstacle candidate information output by the information exclusion unit 33 on the basis of the time-series data of the observation data acquisition unit 32 and the information generation unit 42 corresponding to the movement of the controlled unit 11 is also time-series data. That is, the area corresponding to the controlled unit 11 is excluded in synchronization with the movement of the controlled unit 11. As a method of excluding the area corresponding to the controlled unit 11, a method of comparing the three-dimensional information of the observation data acquisition unit 32 and the information generation unit 42 and a process of representing the three-dimensional information of the observation data acquisition unit 32 and the information generation unit 42 by regular grids (voxels) occupied in a three-dimensional space and detecting the overlap between the grids, for example, a logical arithmetic operation such as exclusive OR (XOR), can also be used. However, the method of excluding the area corresponding to the controlled unit 11 is not limited to these methods. Moreover, preferably, even if the controlled unit 11 is moving, the information exclusion unit 33 can perform a process of excluding the area corresponding to the controlled unit 11 with a sufficiently small delay and the obstacle candidate information does not include the area corresponding to the controlled unit 11. However, when there is a delay in the process of the information exclusion unit 33 or when there is an error between the position or posture of the actual controlled unit 11 and the observation device 2 and the position or posture in the virtual environment 4, i.e., when there is an error in the calibration, the information exclusion unit 33 cannot appropriately exclude the area corresponding to the controlled unit 11, and the obstacle candidate information may include a part of the area corresponding to the controlled unit 11. In such a case, when the information exclusion unit 33 excludes the area corresponding to the controlled unit 11, for example, it is possible to make an adjustment so that the area desired to be excluded is not included by excluding an area slightly larger than that of the three-dimensional information output by the information generation unit 42. It is only necessary to process this adjustment by multiplying the three-dimensional area output by the information generation unit 42 by a coefficient of more than 1, and this coefficient can be appropriately adjusted as a parameter in accordance with the operation speed of the controlled unit 11, the processing capability of the information exclusion unit 33, or the like. Also, the above adjustment is an example and the present invention is not limited thereto.

In the obstacle detection device 3, obstacle candidate information output by the information exclusion unit 33 and information output from the information generation unit 42 in the virtual environment 4 are input to the determination processing unit 34 and the determination processing unit 34 performs a determination process for detecting an obstacle. The obstacle candidate information output by the information exclusion unit 33 is information including an area that the controlled unit 11 should not approach or enter, i.e., an obstacle area. On the other hand, the shape information output from the information generation unit 42 is information within the virtual environment 4 corresponding to the shape and movement of the controlled unit 11. Here, the obstacle candidate information output by the information exclusion unit 33 is based on observation information from the observation device 2 in a real environment. Moreover, the shape information output from the information generation unit 42 is information within the virtual environment. Also, it is assumed that the position, posture, scale, and the like are consistent within a specified error range on the basis of the process of the environment setting unit 41. That is, the determination processing unit 34 can determine whether or not the controlled unit 11 is approaching or entering (or coming into contact with) the obstacle area by comparing the obstacle candidate information output by the information exclusion unit 33 with information dynamically indicating the controlled unit 11, which is shape information output from the information generation unit 42. This determination can be implemented, for example, by calculating a distance between a three-dimensional position indicated in the obstacle candidate information and an aggregate of positions indicated in three-dimensional position aggregate information output by the information generation unit 42 and evaluating whether or not the distance exceeds the set threshold value. Aggregate information that is the three-dimensional position information aggregate, is, for example, point cloud data and can be represented as an aggregate of points indicating three-dimensional coordinates. A distance between aggregates can be calculated as, for example, a Euclidean distance between centers of gravity of the aggregates, a Euclidean distance between nearest points, and the like. The method of finding the nearest point is, for example, a method using an algorithm of a nearest neighbor search, a k-neighbor search, or the like. However, the method of finding the nearest point is not limited to the method using the algorithm of the nearest neighbor search or the k-neighbor search. Moreover, this determination can be implemented in the reverse process to the process of the information exclusion unit 33 described above. In the determination, as in the example of the process of the information exclusion unit 33, the obstacle candidate information and the aggregate information of the three-dimensional positions output by the information generation unit 42 are represented by three-dimensional regular grids (voxels). If there is a matching grid between the grids or between the surrounding grids, it indicates that there is a three-dimensional position where the distance is short.

Therefore, in the determination, for example, a process of finding the overlap between grids at certain predetermined resolution (for example, an XOR operation) is performed. If no overlap is detected, it indicates that the controlled unit 11 is not approaching the obstacle area within a distance range based on the resolution. If the overlap is detected, it indicates that the controlled unit 11 is approaching the obstacle area. Also, the resolution of the overlap detection, i.e., the size of the grid (voxel), depends on the point cloud density (i.e., the size of the mesh) of three-dimensional information and can be appropriately set in accordance with the processing capability of the determination processing unit 34. Preferably, a wide grid size is set and therefore the approach is determined at an early stage, i.e., when a distance between an obstacle area and the controlled unit 11 is close to about the set grid size. On the other hand, a narrow grid size is set and therefore the spatial resolution for determining the distance between the obstacle area and the controlled unit 11, i.e., spatial precision, is improved, so that the controlled unit 11 or the obstacle area with a spatially complex shape can also be determined with high precision. Also, these determination methods are exemplary and may be any method as long as it can be determined whether or not the controlled unit 11 is approaching the obstacle area.

A determination result of the determination processing unit 34 may be published by a display unit (not shown) or the like. Alternatively, a control command output by the control unit 12 of the movable device 1 to the controlled unit 11 may be changed on the basis of the determination result. For example, the control unit 12 may restrict an operation range of the controlled unit 11, limit an operation speed of the controlled unit 11, or stop the controlled unit 11 by changing the control command output to the controlled unit 11. The method of changing these control commands may be any method.

Here, another method of setting the resolution in space for determining the distance between the obstacle area and the controlled unit 11 will be described. Although the resolution in space is set as a threshold value for determining a distance between aggregates of points indicating the three-dimensional coordinates indicated in three-dimensional information or as resolution (a grid size, i.e., a mesh size) when represented by voxels as described above, this value does not need to be set to a single value. For example, a plurality of different values may be set as a threshold value or a grid size. In this case, the determination processing unit 34 can make determination processes in parallel. As described above, in a process of setting the resolution in space, a trade-off is made between time until determination and spatial precision. Therefore, for example, an instruction to decelerate the controlled unit 11 is issued because a large value and a small value are set as a threshold value for the distance and the determination processing unit 34 makes determination quickly when the distance is long in the case of a large value and an instruction to stop the controlled unit 11 is issued because the determination processing unit 34 makes determination with high precision when the distance is short in the case of a small value, such that deceleration and stopping can be determined separately. Even if the grid size is set, the determination processes of the determination processing unit 34 using a wide grid size (coarse resolution) and a narrow grid size (fine resolution) may be similarly performed in parallel. A deceleration instruction may be issued when the determination processing unit 34 makes determination in the wide grid size and a stopping instruction may be issued when the determination processing unit 34 makes determination in the narrow grid size. Thus, by combining a plurality of determination processes of the determination processing unit 34 and a plurality of different instructions from the control unit 12 corresponding to determination results, the trade-off between the time until the determination process of the determination processing unit 34 and the precision of spatial determination can be eliminated. Moreover, after the determination processing unit 34 makes determination using a large distance threshold value or a wide grid size and the controlled unit 11 is decelerated, the control process of the control unit 12 may be returned to the original control when the determination processing unit 34 determines that it is not approaching the obstacle area. Therefore, the control unit 12 can efficiently operate the movable device 1 without excessively stopping the controlled unit 11. Also, the above determination process of the determination processing unit 34 is exemplary and is not limited thereto. For example, the determination processing unit 34 may set multi-step (multi-valued) resolution and make multi-step determination.

### (Operation of Control System)

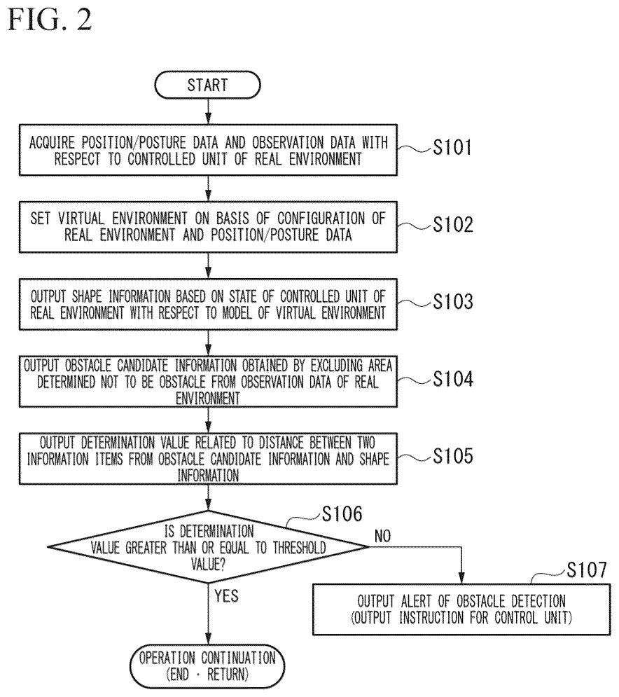

FIG. 2 is a flowchart showing an example of a processing procedure performed by the control system 100 according to the first example embodiment. Next, the process of the control system 100 will be described with reference to FIG. 2. The position/posture data acquisition unit 31 of the obstacle detection device 3 acquires position/posture data from the movable device 1 and the observation data acquisition unit 32 acquires observation data from the observation device 2 (step S101).

Subsequently, the environment setting unit 41 of the obstacle detection device 3 sets the virtual environment on the basis of the configuration of the real environment, the acquired position/posture data, and the like in the virtual environment 4 (step S102). Specifically, the environment setting unit 41 sets a position or posture relationship with respect to the observation device 2 for a model simulating the controlled unit 11 within the virtual environment and an actual observation device 2, i.e., performs a calibration process or a process of reflecting the acquired position/posture data in the model.

Subsequently in the virtual environment 4, the information generation unit 42 outputs shape information based on the state of the controlled unit 11 in the real environment for the simulated model (step S103). Specifically, the information generation unit 42 outputs, for example, a time-series value of an aggregate of three-dimensional positions occupied by the three-dimensional shape of the model within the virtual environment 4 synchronized with the controlled unit 11 of the real environment or a three-dimensional position corresponding to the temporal displacement of the model within the virtual environment 4 synchronized with the controlled unit 11 of the real environment.

Subsequently, the information exclusion unit 33 excludes the area not to be determined to be an obstacle from the observation data of the real environment and outputs excluded obstacle candidate information (step S104). Also, the area not determined to be the obstacle is, for example, an area corresponding to the controlled unit 11 or an area where approach or entry is scheduled in work by the movable device 1, and the area not determined to be the obstacle by the user is registered, or, for example, the information exclusion unit 33 may register it as information in advance.

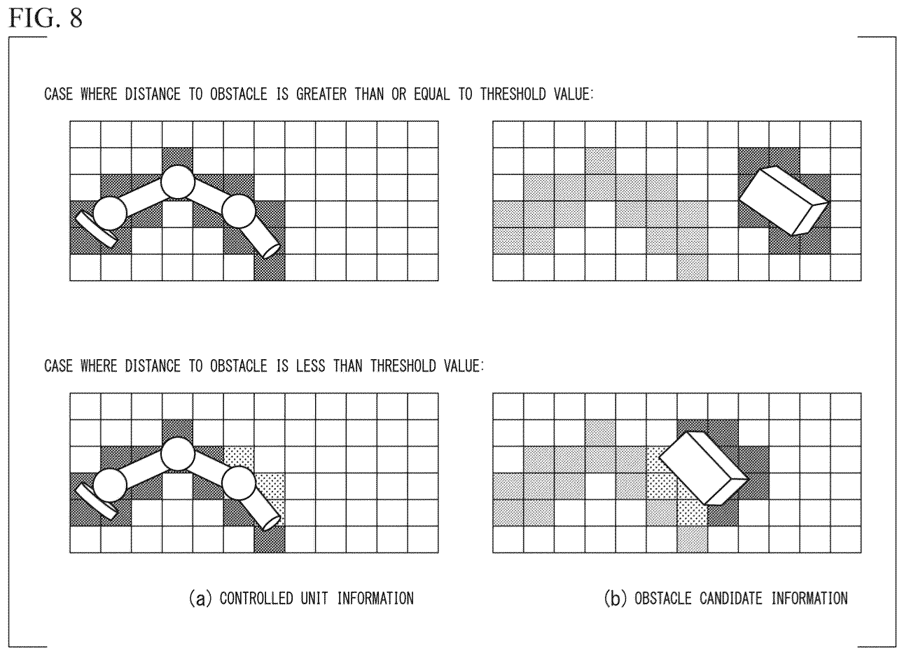

Subsequently, the determination processing unit 34 identifies a value (i.e., correlated with the distance, preferably proportional to the distance) related to a distance between two information items (i.e., a distance between the obstacle area and the controlled unit 11) (hereinafter referred to as a determination value) from the obstacle candidate information and the shape information and outputs the identified determination value (step S105). Examples of the determination value include a value proportional to the distance between the obstacle area and the controlled unit 11, an “overlap” corresponding to the distance between the obstacle area and the controlled unit 11 (for example, a portion indicated by a dot pattern in which the obstacle area and the controlled unit overlap when a distance to the obstacle in FIG. 8 is less than a threshold value), and the like. Specifically, for example, the determination value indicates a distance between a three-dimensional area indicating obstacle candidate information and a three-dimensional area indicating a dynamic shape of the controlled unit 11. A threshold value is appropriately set in accordance with a type of determination value output by the determination processing unit 34. The determination processing unit 34 determines whether or not the determination value is greater than or equal to the threshold value (step S106). When the determination value is greater than or equal to the threshold value (step S106; YES), the determination processing unit 34 determines that it is safe because the distance between the controlled unit 11 and the obstacle area is far away, the movable device 1 continuously operates, and the main flow returns to the start (subsequently, the process starting from step S101 is iterated). On the other hand, when the determination value is less than the threshold value (step S106; NO), the determination processing unit 34 determines that the controlled unit 11 is approaching or entering the obstacle area and outputs an alert indicating that the obstacle has been detected (step S107). The determination processing unit 34 outputs an instruction to the control unit 12 of the movable device 1. Also, the instruction from the determination processing unit 34 to the control unit 12 may be used to appropriately select an instruction to restrict the operation range of the controlled unit 11, limit the operation speed thereof, or stop the controlled unit 11, or the like, or may be set to be a different instruction in association with the determination value in advance.

After a process of a case where an obstacle is detected (the processing of step S107), the main flow basically returns to the start (subsequently, the process starting from step S101 is iterated). In this regard, when the main flow returns to the start at least once, when the controlled unit 11 stops according to an instruction for the control unit 12, or the like, return work for moving the controlled unit 11 away from the obstacle area or the like is appropriately performed.

According to the above operation flow shown in FIG. 2, the controlled unit 11 of the movable device 1 can be safely operated without approaching or entering the area of the obstacle observed by the observation device 2. Moreover, by executing an instruction not to stop the controlled unit 11 among the instructions for the control unit 12 described in the processing (step S107) when an obstacle is detected, the deterioration in work efficiency due to stopping can be prevented, and safe and efficient work can be performed.

### (Advantages)

The control system 100 according to the first example embodiment has been described above. Here, the advantages of the control system 100 over a control system that is a comparison target will be described.

First, features of the control system to be compared with the control system 100 of the first example embodiment will be described. In the control system that is the comparison target with an obstacle detection function, there are typically two types of obstacle detection methods. The first obstacle detection method is a method of setting an area determined to be an obstacle in advance on the basis of an observation result and a movable range of the movable device 1. Because this method includes the processing to set in advance, it is difficult to make an error in determination or overlook it. However, because it is necessary to set the area in advance, it is difficult to set the area according to the necessary minimum area or the dynamically changing area for the changing environment or obstacle. Therefore, in this method, there is a possibility that a wider area than necessary (i.e., a margin is provided) is set in advance and the determination processing unit 34 may make determination excessively. That is, when this method is used, there is a possibility that the work efficiency may deteriorate by decelerating or stopping the movable device 1 due to the determination of the determination processing unit 34. The second obstacle detection method is a method of detecting an obstacle on the basis of observation information and estimating its position. For example, a technique for detecting a physical object in deep learning or the like can be applied, but it may be necessary to learn a physical object detection target in advance, or there may be no guarantee that unknown obstacles can be reliably detected. That is, there is a possibility of false detection and oversight (detection omission). From the above, in the control system that is the comparison target, it is difficult to control the controlled unit 11 precisely with high work efficiency while detecting obstacles with high safety or reliability.

Next, features of the control system 100 according to the first example embodiment will be described. The control system 100 according to the first example embodiment does not perform a process of presetting an area or a physical object related to an obstacle or detecting the obstacle or the physical object in advance, and sets all areas other than the area or the physical object determined not to be an obstacle from the observation information, i.e., an area where entry is allowed depending on the controlled unit 11 or work, as obstacle candidate information. That is, in the control system 100, there is no oversight that an obstacle is not detected. Also, the control system 100 makes determination by comparing the obstacle candidate information with the information of the virtual environment in which the shape and operation of the actual controlled unit 11 are simulated. Therefore, in the control system 100, because the obstacle candidate information and the information of the controlled unit 11 are generated as different information and compared, a process of extracting the area of the controlled unit 11 from the observation information or estimating a distance between the obstacle and the controlled unit 11 from the same observation information is not performed. That is, in the control system 100, processing errors and/or estimation errors do not occur. Furthermore, in the control system 100, even if a part of the observation information about the controlled unit 11 is missing, i.e., a part of the controlled unit 11 is shielded, because the information generated in the virtual environment is based on the shape model of the controlled unit 11, the control system 100 is affected by missing or shielding of information and has high robustness. Thus, the control system 100 is characterized in that no physical object detection method is used and that determination is made from the observation information and information based on the model of the virtual environment. As compared with the control system that is the comparison target, it is possible to control the controlled unit 11 precisely with high work efficiency while detecting an obstacle with high safety or reliability.

### Second Example Embodiment

### (Configuration of Control System)

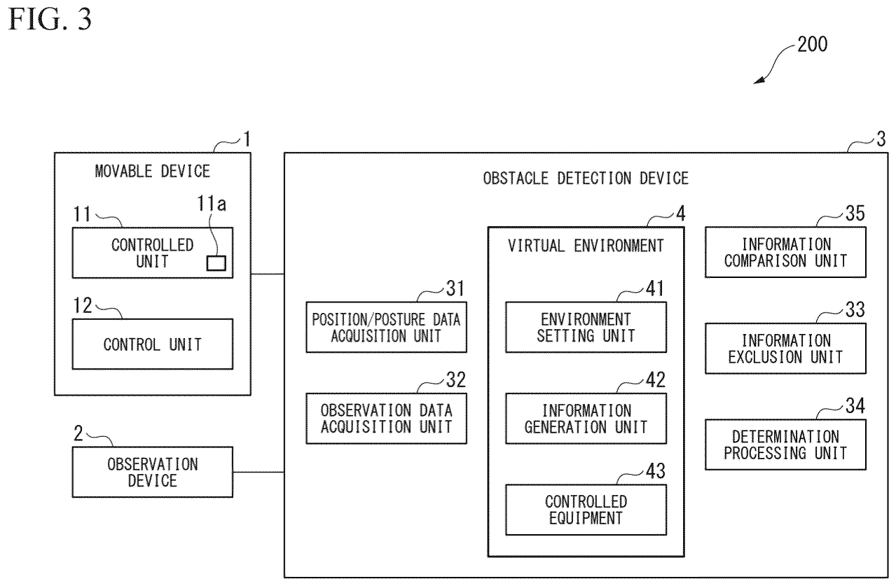

FIG. 3 is a diagram showing an example of a configuration of a control system 200 according to a second example embodiment. As shown in FIG. 3, the control system 200 includes an obstacle detection device 3 further including an information comparison unit 35 in addition to the configuration of the control system 100 according to the first example embodiment shown in FIG. 1. Because the other constituent elements are similar to those of the control system 100 according to the first example embodiment, description thereof will be omitted below.

In the obstacle detection device 3, observation information included in an observation range of a controlled unit 11 acquired by an observation data acquisition unit 32 and shape information about a model simulating a controlled unit 11 generated by an information generation unit 42 of a virtual environment 4 are input to the information comparison unit 35. In a state in which a process of the environment setting unit 41 is ideally executed, i.e., a position or posture relationship between a model simulating the controlled unit 11 in the virtual environment and the observation device 2 is within a specified error range (calibrated state), and the dynamic displacement of the controlled unit 11 is reflected in the model, two three-dimensional information items input to the information comparison unit 35 are equivalent. Specifically, three-dimensional information in which the shape of the controlled unit 11 included in the observation information is reflected and three-dimensional information in which a shape indicated by the model synchronized with the controlled unit 11 generated by the information generation unit 42 of the virtual environment 4 is reflected are consistent within a certain fixed error range. Hereinafter, three reasons will be classified and described. The first reason is based on the definition of a model simulating the controlled unit 11 in the virtual environment 4. Because this model simulates the shape of the actual controlled unit 11, the three-dimensional information based on the shape, i.e., the three-dimensional information of the portion occupied by the controlled unit 11 indicated by the model in the virtual space, is equivalent to the three-dimensional information obtained by observing the controlled unit 11 with the observation device 2 in a real space. The second reason is that a coordinate system of the observation device 2 in the real space is consistent with a coordinate system that generates the shape information indicated by the model. This is because the environment setting unit 41 sets (calibrates) position and posture relationships between the controlled unit 11 and the observation device 2 so that they match the relationship between the model within the virtual environment 4 and a reference point when the shape information included in the model is generated. The third reason is that the dynamic displacement of the controlled unit 11 is acquired via the position/posture data acquisition unit 31 and is reflected in the model within the virtual environment 4 by the environment setting unit 41. That is, the operations of the controlled unit 11 and the model can be considered to be synchronized within a certain specified delay time range. Therefore, even if the controlled unit 11 moves, two three-dimensional information items input to the information comparison unit 35 are consistent within a certain specified delay time range.

On the other hand, when there is a difference between information items input to the information comparison unit 35, i.e., when there is an error in the position and posture in a certain space or a difference that exceeds a range of time delay, it can be determined that any one of the three reasons described above is not valid, i.e., the state is not an ideal operating state. Specifically, the state is as follows. First, in correspondence with the first reason, there is a mismatch in shape between the actual controlled unit 11 and the model within the virtual environment 4. This state may occur, for example, when a movable device different from the assumed movable device 1 is connected, or when there is an error in the process of the environment setting unit 41 of the virtual environment 4.

Next, there is a misalignment in a coordinate system in correspondence with the second reason. As this state, a case where the calibration is inappropriate, a case where the position and posture of the observation device 2 change after calibration, and the like are considered. For example, this state can occur when a problem occurs in the observation device 2. Next, the position/posture data of the controlled unit 11 cannot be properly acquired in correspondence with the third reason. This state can occur, for example, when a failure in a sensor that acquires the position and posture of the controlled unit 11, a failure in a path connecting the movable device 1 and the obstacle detection device 3, a failure in a process of the position/posture data acquisition unit 31, or the like is occurring.

Determination of these failures can be implemented by evaluating a distance between information items input to the information comparison unit 35, i.e., between aggregate information items of points indicating three-dimensional coordinates indicated in the three-dimensional information. A distance calculation method can be applied, for example, to a method equivalent to the process of the determination processing unit 34 described in the first example embodiment. Specifically, if a distance between two input information items is less than a threshold value, the information comparison unit 35 determines that the two information items are the same, i.e., there is no failure. On the other hand, when the distance is greater than or equal to the threshold value, the information comparison unit 35 determines that the two information items are not the same, i.e., there is a failure. When it is determined that there is a failure, the determination processing unit 34 sends an alert or an instruction to the control unit 12 as in a case where an obstacle is detected. The threshold value for the determination can be appropriately set in accordance with a size, an operation speed, an amount of information (divisible), and the like of the controlled unit 11.

### (Operation of Control System)

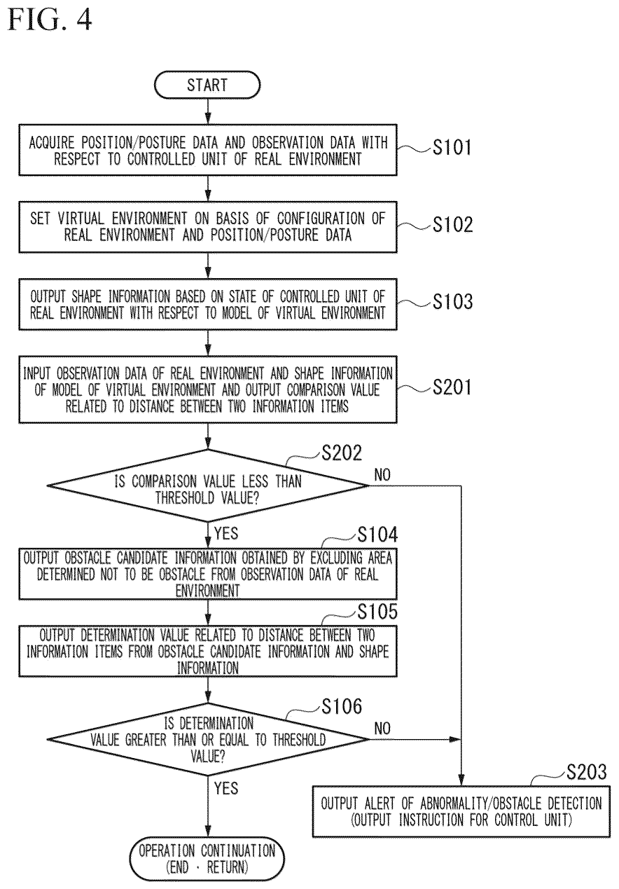

FIG. 4 is a flowchart showing an example of a processing procedure performed by the control system 200 according to the second example embodiment. A process of the control system 200 will be described with reference to FIG. 4. Also, processing steps similar to those of the control system 100 according to the first example embodiment among the processing steps shown in FIG. 4 are denoted by the same step numbers and description thereof will be omitted.

After the control system 200 performs the processing of steps S101 to S103 as in the control system 100 according to the first example embodiment, observation data of a real environment acquired by the observation data acquisition unit 32 and shape information generated by the information generation unit 42 for a model of a virtual environment are input to the information comparison unit 35 and the information comparison unit 35 outputs a comparison value related to a distance between two information items (that is, a distance between an obstacle area and the controlled unit 11) (step S201).

Subsequently, the comparison value is compared with the threshold value and the information comparison unit 35 determines that there is no failure in the control system 200 when the comparison value is less than the threshold value (step S202; YES) and subsequently a flow (steps S104 to S106) similar to that of the first example embodiment is operated. On the other hand, when the comparison value is greater than or equal to the threshold value (step S202; NO), the information comparison unit 35 determines that there is a failure in the control system 200 and outputs a failure or obstacle detection alert (step S203). Although this flow has a similar process when an obstacle is detected (step S106; NO) as in the control system 100 according to the first example embodiment, an alert is also output when there is a problem in the control system 200 according to the second example embodiment. As described above, because failure and obstacle detections are differently determined (steps S201 and S106), an identifiable alert may be output in each detection. Moreover, in addition to the alert, an instruction may be output to the control unit 12.

### (Advantages)

The control system 200 according to the second example embodiment has been described above. In the control system 200 according to the second example embodiment, in addition to the control system 100 according to the first example embodiment, the information comparison unit 35 is further provided and it is possible to detect a failure related to the correspondence between the movable device 1 and the virtual environment 4, a failure related to the position and posture of the observation device 2, a failure related to the calibration, a failure of a signal path connecting the movable device 1 or a sensor that acquires position and posture information of the controlled unit 11, or the like as described above. That is, before it is determined whether or not the controlled unit 11 is approaching or entering the obstacle area, the movable device 1, the observation device 2, and the obstacle detection device 3 are in a state in which it is possible to detect whether or not the determination can be performed normally, i.e., a case where there is a failure in the control system 200. Thereby, it is possible to isolate and detect obstacle-related detection and other system failures.

Therefore, the control system 200 can detect the obstacle more reliably by performing recovery measures when a failure state is detected.

### Third Example Embodiment

### (Configuration of Device)

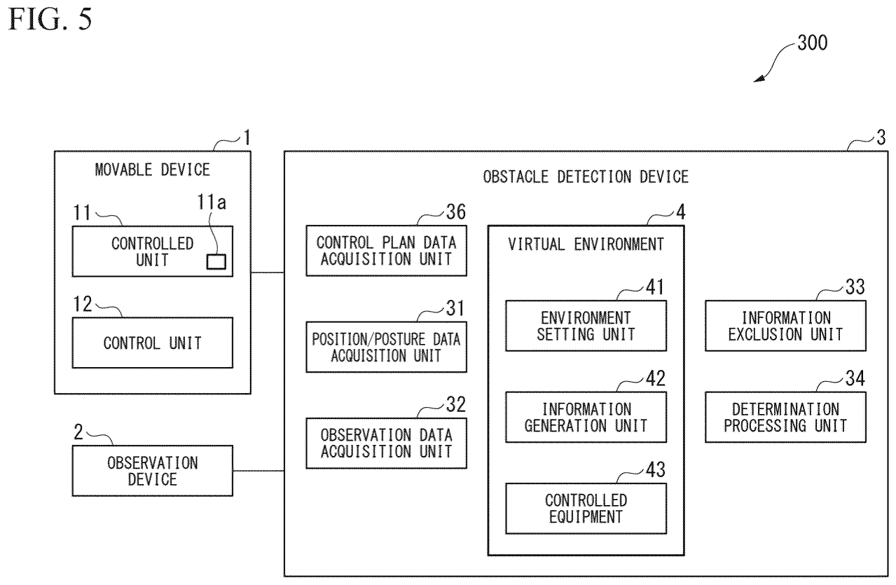

FIG. 5 is a diagram showing an example of a configuration of a control system 300 according to the third example embodiment. The control system 300 shown in FIG. 5 includes an obstacle detection device 3 further including a control plan data acquisition unit 36 in addition to the control system 100 according to the first example embodiment. Because the other constituent elements are similar to those of the control system 100 according to the first example embodiment, description thereof will be omitted below. Moreover, a configuration combined with the second example embodiment, i.e., a configuration further including an information comparison unit 35, is also possible. In an obstacle detection device 3 provided in the control system 300 according to the third example embodiment, the control plan data acquisition unit 36 acquires information of a control plan for controlling the controlled unit 11 of the movable device 1. Preferably, the control plan data acquisition unit 36 acquires a control signal generated by a control unit 12. However, this does not apply when the control plan is generated by another device. Also, in the third example embodiment, any generation method and any acquisition path may be used for the generation of the control plan and the acquisition path as long as a desired control plan is generated and appropriate information can be transmitted along the acquisition path. The information of the control plan may be, for example, information of a target position when a specific portion of the controlled unit 11 moves from a current position to the target position, or a control value of the movable unit 11a (actuator) constituting the controlled unit 11 at that time. Whereas the position/posture data acquisition unit 31 acquires current position/posture information of the controlled unit 11, the control plan data acquisition unit 36 preferably acquires position/posture information for which future control is planned (scheduled). A frequency of acquiring information of this future control plan may be acquired at each specific operation or time when the target position changes, or periodically. That is, the information of the future control plan is time-series information like the current position/posture information acquired by the position/posture data acquisition unit 31.

The information of the future control plan acquired by the control plan data acquisition unit 36 is input to the environment setting unit 41 of the virtual environment 4. In the first or second example embodiment, the environment setting unit 41 sets the position and/or posture of the model simulating the controlled unit 11 on the basis of the current position/posture information acquired by the position/posture data acquisition unit 31. That is, the model is synchronized (in synchronization) with the current state of the actual controlled unit 11. This point does not change in the third example embodiment, but the third example embodiment is different from the first and second example embodiments in that a model simulating another controlled unit 11 is provided. Also, the position and/or posture of the model are set on the basis of the control plan information acquired by the control plan data acquisition unit 36. That is, this model is synchronized with a state given in the control plan. Thus, in the virtual environment 4, the third example embodiment is characterized in that different states of the controlled unit 11, i.e. the current state and the state based on the control plan, are reproduced. Here, an example of the current state and the state based on one type of control plan, i.e., the case of two states, is shown, but the number of states to be reproduced is not limited to this. That is, a plurality of different states may be reproduced on the basis of the information of the control plan at a plurality of different timings.

The information generation unit 42 in the virtual environment 4 of the third example embodiment performs a process on a plurality of different state models described above. That is, the information generation unit 42 generates position information occupied by a three-dimensional shape of the model corresponding to a current position/posture of the controlled unit 11 and position information occupied by a three-dimensional shape of the model corresponding to the position/posture of the controlled unit 11 scheduled on the basis of the control plan. Also, a method similar to that of the first example embodiment can be applied to this generation process of the information generation unit 42, and the number of information items to be generated corresponds to the number of different models. That is, as described above, when a plurality of different models are reproduced on the basis of a plurality of different control plans, the information generation unit 42 generates information items equal in number to the number of different models.

Because the inputs and outputs of the observation device 2, the observation data acquisition unit 32, and the information exclusion unit 33 are similar to those of the first example embodiment, description thereof will be omitted.

### (Operation of Control System)

A process performed by the control system 300 according to the third example embodiment is basically similar to the flowchart of the control system 100 according to the first example embodiment shown in FIG. 2. As described above, the control system 300 according to the third example embodiment can also be applied to the control system 200 according to the second example embodiment. Therefore, the process performed by the control system 300 according to the third example embodiment can be similar to the process indicated by the flowchart of the control system 200 according to the second example embodiment shown in FIG. 4.

### (Advantages)

The control system 300 according to the third example embodiment has been described above. As in the determination processing unit 34 of the first example embodiment, obstacle candidate information output by the information exclusion unit 33 and three-dimensional shape information based on a plurality of models output by the information generation unit 42 are input to the determination processing unit 34 of the third example embodiment. A method of performing a determination process on the basis of this information will be described. The control system 300 of the third example embodiment is similar to the control system 100 according to the first example embodiment in that it outputs a determination value related to a distance between two information items which are the obstacle candidate information and the shape information output by the information generation unit 42 and a similar method can be applied. However, in the third example embodiment, because there are a plurality of shape information items output by the information generation unit 42, the control system 300 processes each of the plurality of shape information items. That is, in the control system 300, the control plan data acquisition unit 36 performs a process of receiving and determining obstacle candidate information and shape information generated from a model corresponding to the current state of the controlled unit 11 and a process of receiving and determining obstacle candidate information and shape information generated from a model corresponding to the state of the controlled unit 11 based on the control plan. Preferably, even if there are a plurality of shape information items, the control plan data acquisition unit 36 can perform the above-described processes in parallel. As a result, the control plan data acquisition unit 36 can output a determination result for each shape information item and can issue an instruction to cope with each different situation, i.e., an instruction for the movable device 1, to the control unit 12. For example, the control plan data acquisition unit 36 can output an instruction to decelerate the controlled unit 11 from the determination result based on the control plan and output an instruction to stop the controlled unit 11 from the determination result based on the current state of the controlled unit 11. Thus, the control plan data acquisition unit 36 determines not only the current state but also the future planned state and therefore the control system 300 can cope with the state at an early stage before actually starting to move. In particular, when the operation speed of the controlled unit 11 is high or the like, even if determination and handling processes are performed for the current state, there is a possibility that a process in which the control unit 12 controls the controlled unit 11 cannot be performed in time due to the influence of a data transmission/reception delay and a processing delay or the like. In this case, by applying the control system 300 according to the third example embodiment, even in the case of the movable device 1 having a fast operation speed or a large delay, an obstacle can be determined and the control unit 12 can control the controlled unit 11.

Hereinafter, application examples based on the first to third example embodiments will be described.

### First Application Example

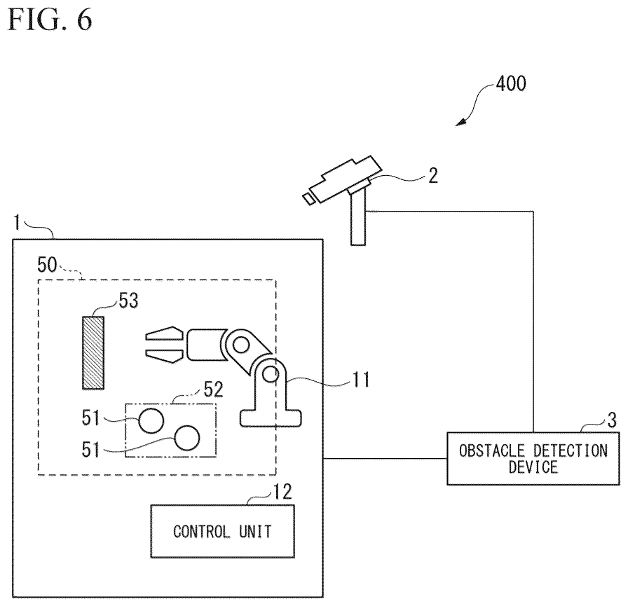

A first application example is an example in which the movable device 1 according to the first or second example embodiment is a robot having an arm, a so-called articulated robot arm. FIG. 6 is a diagram showing an example of a configuration of a control system 400 of the first application example.

The first application example shows the configuration of the control system 400 in which the movable device 1 includes a robot arm 11, the observation device 2 is a device capable of acquiring three-dimensional information such as a depth camera or a LiDAR sensor, and the obstacle detection device 3 is any one obstacle detection device 3 in the first to third example embodiments. Although a configuration in which the movable device 1 and the observation device 2 are each connected to the same obstacle detection device 3 is provided in FIG. 6, the number of connected movable devices 1, the number of connected observation devices 2, and configurations thereof are not limited thereto. For example, a plurality of movable devices 1 and one observation device 2 may be connected to the obstacle detection device 3.

The movable device 1 includes at least the controlled unit 11 and the control unit 12 like the movable device 1 of the first or second example embodiment. In the first application example, the robot arm 11 is the controlled unit 11 and a controller 12 is the control unit 12 that controls the robot arm 11. Also, in FIG. 6, one robot arm 11 is the controlled unit 11, but a plurality of robot arms 11 may be collectively used as the controlled unit 11. Furthermore, the controlled unit 11 may be mounted on a moving device such as a movable unmanned (autonomous) guided vehicle (AGV) and a hardware-related configuration of the movable device 1 is not limited to the configuration described in the first application example. In this regard, the robot arm 11 includes a movable unit 11a and the movable unit 11a is likely to approach or enter a nearby obstacle or obstacle area. Also, the control unit 12 may be included in the movable device 1 or may be present in another location connected by a network and any configuration of the control unit 12 and any control signal can be used as long as the desired control can be performed and the desired control signal can be generated.

In the first application example, the observation device 2 is a device capable of acquiring three-dimensional information such as a depth camera or a LiDAR sensor like the observation device 2 of the first or second example embodiment. A position at which the observation device 2 is installed is not particularly limited, but it is assumed that at least a part of a housing of the robot arm 11 is included at the position. In FIG. 6, an example of an observation area 50 observed (imaged) by the observation device 2 is shown. Also, the observation device 2 may be mounted on the robot arm 11. Moreover, when the robot arm 11 is mounted on a moving device such as an autonomous guided vehicle, the observation device 2 may be mounted on the moving device.

In the following description, as an example in which actual work (task) is controlled using the control system 400, the movable device 1 includes the robot arm 11 and a task of grasping (picking) a target object will be described. Also, for the task content, in the first application example, it is not limited to the task in which the robot arm 11 grasps a target object. In FIG. 6, an example of the observation area 50 observed by the observation device 2 is shown. As described above, the observation area 50 includes at least a portion of the robot arm 11. Moreover, it is assumed that the target object grasped in this task is illustrated as a target object 51 in FIG. 6 and the target object 51 is included in the observation area 50. Although an example in which the number of target objects 51 is two is shown in FIG. 6, the present invention is not limited thereto. Here, the robot arm 11 needs to approach the target object 51 and finally come into contact with the target object 51 so that the robot arm 11 performs a task of grasping the target object 51. Typically, the robot arm 11 includes an end effector such as a robot hand and the robot arm 11 performs a grasping task in which the end effector and the target object 51 come into contact with each other. In other words, the robot arm 11 comes into contact with the target object 51, but the target object 51 is not an obstacle, i.e., approach or contact thereof needs to be allowed. Therefore, an area where contact with the robot arm 11 is allowed is shown as the target area 52 in FIG. 6. Although the target area 52 is an area including two target objects 51 because the first application example is an example of a task for grasping two target objects 51, a method of setting the target area 52 is not limited. For example, the target area 52 may be set for each target object according to an outer circumferential surface of the target object or may be set to add a specified margin on the outer circumferential surface of the target object or to include a plurality of target objects. Moreover, in FIG. 6, an obstacle or obstacle area 53 that the robot arm 11 is not allowed to approach or enter is shown. The obstacle area 53 may be, for example, a structure, another physical object not to be grasped, or an area that does not have a physical form and where entry is not allowed. Furthermore, the obstacle area 53 may be a plurality of obstacle areas. In this regard, it assumed that the obstacle area 53 is defined as a range included in the observation area 50. That is, when the obstacle area is continuous beyond the observation area 50, a range defined by the observation area 50 becomes the obstacle area 53.

Hereinafter, a method in which the robot arm 11 performs the task of grasping the target object 51 without approaching or entering the obstacle area 53 using the obstacle detection device 3 according to the first to third example embodiments will be described. The position/posture data acquisition unit 31 of the obstacle detection device 3 acquires information of each joint (the movable unit 11a) constituting the robot arm 11 and the observation data acquisition unit 32 acquires three-dimensional information of the observation area 50. The virtual environment 4 constructs a model simulating the three-dimensional shape and movement of the robot arm 11. The model is set by the environment setting unit 41 on the basis of the information acquired by the position/posture data acquisition unit 31 and therefore the actual robot arm 11 and the model within the virtual environment 4 are in a synchronized state, i.e., the position and/or posture are consistent within a certain specified error range. Moreover, on the basis of a position or posture relationship between the actual robot arm 11 and the observation device 2, a model is set, i.e., calibrated, by the environment setting unit 41 within the virtual environment 4. As a result, among information items acquired by the observation data acquisition unit 32, a position in a three-dimensional space occupied by the robot arm 11 and a position in a three-dimensional space occupied by the model generated by the information generation unit 42 are consistent within a certain specified error range.

FIG. 7 is a diagram for describing a specific example of a process of the information comparison unit 35 according to the first application example. Here, a specific example of the process of the information comparison unit 35 when the obstacle detection device 3 of the second example embodiment is used will be described with reference to FIG. 7. In the control system 400, among the information items observed by the observation device 2 and acquired by the observation data acquisition unit 32, a position in the three-dimensional space occupied by the robot arm 11 is shown as the real environment of the part of (a) of FIG. 7. Moreover, the position in the three-dimensional space occupied by the model generated by the information generation unit 42 within the virtual environment 4 is shown as the virtual environment of the part of (b) of FIG. 7. Moreover, the upper part of FIG. 7 shows a case where a comparison value output by the information comparison unit 35 is less than a threshold value, i.e., a state in which the comparison value between the real environment and the virtual environment coincides within a certain specified error range. Moreover, the lower part of FIG. 7 shows a case where the comparison value output by the information comparison unit 35 is greater than or equal to the threshold value, i.e., a state in which there is a failure in the control system 200 described in the second example embodiment. Although information actually input to the information comparison unit 35 is three-dimensional, the information is two-dimensionally represented in FIG. 7 for convenience. The grid shown in FIG. 7 corresponds to the resolution of the coordinates when a process of the information comparison unit 35 is performed and is generally represented by a regular grid (voxel) in the case of three dimensions. In the case of an aggregate of input three-dimensional position information, for example, point cloud data, the grid including each three-dimensional coordinate is occupied by a physical object and is represented in black in the grid shown in FIG. 7. On the other hand, other grids that are not included in the input three-dimensional coordinates are represented in white in FIG. 7. That is, as shown in FIG. 7, the grid occupied by the robot arm 11 is represented in black and the other grids are represented in white.

Thus, the state of each grid can be represented by a binary value (binary variable: 0 or 1) indicating whether it is occupied (black: 1) or unoccupied (white: 0). At this time, when the state of a k^{th} grid of the real environment shown in the part of (a) of FIG. 7 is denoted by C_{real, k}, the state of a k^{th} grid of the virtual environment shown in the part of (b) of FIG. 7 is denoted by C_{sim, k}, an overlap ΔCₖ of the grid k is represented when a method using the above-described XOR operation is applied.

$$\begin{matrix}[ Math . 1 ] & \\ Δ {C}_{k} = {C}_{real , k} {XORC}_{sim . , k} & ( 1 )\end{matrix}$$

That is, when the state of the grid k is the same in the real environment shown in the part of (a) of FIG. 7 and the virtual environment shown in the part of (b) of FIG. 7, i.e., both are occupied or not occupied together, an overlap ΔCₖ of the grid k is 0. On the other hand, when the grid k is occupied by either the real environment shown in the part of (a) of FIG. 7 or the virtual environment shown in the part of (b) of FIG. 7, the overlap ΔCₖ of the grid k is 1. Here, when the number of grid points used for determination is N, the comparison value output by the information comparison unit 35 is, for example, a value obtained by summing overlaps ΔCₖ of grids k represented by Eq. (1) for all grid points, i.e., Expression (2).

$$\begin{matrix}[ Math . 2 ] & \\ {{\sum }^{N}}_{k} Δ {C}_{k} & ( 2 )\end{matrix}$$

Here, in the calculations of Eq. (1) and Expression (2), the number of grid points N is determined according to a volume of the target observation area 50 and the resolution (grid size) of the grid, and an amount of calculation increases as N increases. However, for example, it is possible to perform high-speed calculations by representing three-dimensional information in an octree. However, the first application example is not limited to a calculation method to which the octree is applied. Here, in a state where the real environment shown in the part of (a) of FIG. 7 and the virtual environment shown in the part of (b) of FIG. 7 coincide within a certain specified error range, ideally, the overlap ΔCₖ of the grid k in each grid k is 0, i.e., the value of Expression (2) is 0. However, because there is an influence of the resolution of the grid, the noise of the observation device 2, or the like, the appropriate determination can be made by setting a threshold value ε that is a value greater than 0 instead of 0 in practice. That is, a “case where the comparison value is less than the threshold value” in the upper part of FIG. 7 is a case where the value of Expression (2) is less than the threshold value &, and includes a case where the value of Expression (2) is 0. In this case, as is clear from FIG. 7, the grid occupied by the robot arm 11 coincides with the real environment shown in the part of (a) of FIG. 7 and the virtual environment shown in the part of (b) of FIG. 7. On the other hand, a “case where the comparison value is greater than or equal to the threshold value” in the lower part of FIG. 7 indicates a case where the value of Expression (2) is greater than or equal to the threshold value. In this case, as is clear from FIG. 7, the grid occupied by the robot arm 11 is different between the real environment shown in the part of (a) of FIG. 7 and the virtual environment shown in the part of (b) of FIG. 7. That is, a state in which there is a failure in the control system 400 is indicated. Also, because the setting of the threshold value ε depends on the size of the robot arm 11, the range of the observation area 50, the resolution, and the like, and depends on the extent to which the error of the real environment and the virtual environment is allowed, it is only necessary to appropriately make decision and a decision method is not limited in the first application example. Thus, the control system 400 can operate a process (step S202) of determining the failure of the control system 200 shown in the flowchart of FIG. 4. Also, the method of determining the above-described failure is an example and the present invention is not limited to this method.

Next, a specific example of the process of the information exclusion unit 33 when the value of Expression (2) is less than the threshold value in the determination process of the information comparison unit 35 or when the obstacle detection device 3 of the first example embodiment is used will be described. The information exclusion unit 33 performs a process of excluding information from the information acquired by the observation data acquisition unit 32 on the basis of the information generated by the information generation unit 42. That is, the process is a process of removing information of a part corresponding to the robot arm 11 of the virtual environment shown in (b) of FIG. 7 from the information shown in the real environment shown in (a) of FIG. 7. Therefore, when there is no failure in the control system 400 (the comparison value is less than the threshold value in FIG. 7), the grid (black) occupied by the robot arm 11 shown in the real environment shown in (a) of FIG. 7 is in an unoccupied state (white). That is, an area occupied by the robot arm 11 included in the observation area 50 is removed from the information acquired by the observation data acquisition unit 32. Specific removal includes, for example, a method in which each information item is represented in a three-dimensional octree and the equally occupied grid is replaced with information indicating that it is not occupied as in the above-described process of the information comparison unit 35. Alternatively, as three-dimensional data for the model corresponding to the information generation unit 42 and the robot arm 11, a reference position of each housing, for example, a position of a center of gravity or a center, a distance from the position to a surface of the housing, and the like are calculated. There is a method of removing an area in a three-dimensional space defined by the data from an aggregate (point cloud) of three-dimensional data acquired by the observation data acquisition unit 32. That is, the information exclusion unit 33 filters a portion of the robot arm 11 from the observation data. However, a method in which the information exclusion unit 33 excludes data is not limited to these methods. Moreover, the process in which the information exclusion unit 33 excludes data is dynamically executed in accordance with the operation of the robot arm 11. That is, even if the robot arm 11 moves, the movement is tracked and data is continuously excluded. Also, when there is a failure in the control system 400 (the comparison value is greater than or equal to the threshold value in FIG. 7), as shown in the lower part of FIG. 7, portions corresponding to the robot arm 11 of the real environment shown in the part of (a) of FIG. 7 and the virtual environment shown in the part of (b) of FIG. 7 do not coincide. Therefore, even if the exclusion process is performed by the information exclusion unit 33, the portion corresponding to the robot arm 11 remains without being excluded. That is, because the portion of the robot arm 11 remaining without being excluded is determined to be an obstacle, the process of the determination processing unit 34 cannot be appropriately executed.

Next, a process peculiar to the first application example will be described with respect to the process of the information exclusion unit 33. In the first application example, as described above, because the robot arm 11 performs a task of grasping the target object 51, it is necessary to exclude the target object 51 from the determination as an obstacle. Therefore, the process of the information exclusion unit 33 is performed on an area corresponding to the robot arm 11 and a target area 52 including the target object 51. The area corresponding to the robot arm 11 is as described above. There is a method in which the environment setting unit 41 provided in the virtual environment 4 sets a three-dimensional area corresponding to the target area 52, i.e., a model, and the information generation unit 42 outputs three-dimensional information about the area, for example, as in the robot arm 11, for the target area 52. The position of the model corresponding to the target area 52 is determined on the basis of a result of recognizing a position (and posture) of the target object 51 from the observation information about the target object 51. Although a method of recognizing the position of the target object 51 is not limited in the first application example, autonomous physical object recognition using point cloud processing or deep learning or a position designated by the user or another device may be adopted to recognize the position of the target object 51. Thus, the target area 52 is identified in the coordinate system of the observation device 2 as in the robot arm 11. Therefore, as in the process of excluding the portion corresponding to the robot arm 11, the target area 52 can be excluded from the information obtained by the observation data acquisition unit 32. From the above, information from which the robot arm 11 and the target area 52 are excluded becomes obstacle candidate information of the first to third example embodiments. Although only the area where the target object is grasped has been considered and described in the first application example, an area where a grasped physical object is placed may be set in the task of the actual robot arm 11. In this case, it is possible to arbitrarily add an area to be excluded like the target area 52 of the first application example on the basis of the task or the user's instruction and the number of areas to be excluded is not particularly limited. The addition of the area to be excluded and the exclusion method are similar to the addition of the exclusion area of the target area 52 and the exclusion method. The above process corresponds to the operation of step S104 in the flowchart shown in FIG. 2 or 4 of the first or second example embodiment.

Next, a specific example of the process of the determination processing unit 34 will be described with reference to FIG. 8. FIG. 8 is a diagram for describing the process of the determination processing unit 34 according to the first application example. Here, as a specific example of the process performed by the determination processing unit 34, a determination process based on the overlap between the grids will be described. In FIG. 8, controlled unit information shown in the part of (a) of FIG. 8 output from the information generation unit 42 in the virtual environment 4, i.e., the three-dimensional information indicating the robot arm 11, and three-dimensional information indicating obstacle candidate information shown in the part of (b) of FIG. 8 output from the information exclusion unit 33 are shown. For convenience, FIG. 8 is shown in two dimensions as in FIG. 7, and the state of each grid is represented in black when the grid is occupied and is represented in white when it is not occupied or there is no information. Moreover, in the obstacle candidate information shown in the part of (b) of FIG. 8, a cube is schematically represented as an example of an obstacle. For description, the grid corresponding to the robot arm 11, which is the controlled unit information shown in the part of (a) of FIG. 8, is represented in an intermediate color between white and black (for example, gray). First, in the determination method based on the overlap between the grids, information output from the information generation unit 42 in the virtual environment 4 and obstacle candidate information output from the information exclusion unit 33 are represented by voxels. Specifically, the state of the k^{th} grid based on the controlled unit information shown in the part of (a) of FIG. 8 is denoted by C_{robot, k′} and the state of the k^{th} grid based on the obstacle candidate information shown in the part of (b) of FIG. 8 is denoted by C_{env., k′}. At this time, the overlap between the grids k is represented using an XOR operation similar to that of Eq. (1).

$$\begin{matrix}[ Math . 3 ] & \\ Δ {C}_{k}^{′} = {C}_{robot , {k}^{′}} {XORC}_{env . , {k}^{′}} & ( 3 )\end{matrix}$$

The upper part of FIG. 8 shows an example of “a case where the distance to the obstacle is greater than or equal to the threshold value.” In this case, as is clear from the relationship between the grid (gray) corresponding to the robot arm 11 of the obstacle candidate information shown in the part of (b) of FIG. 8 and the grid (black) corresponding to the obstacle, there is no grid that matches the occupied state in the controlled unit information shown in the part of (a) of FIG. 8 and the obstacle candidate information shown in the part of (b) of FIG. 8. That is, for the occupied grid k, the value of the overlap ΔC_{k′} of the grid k of Eq. (3) is 1. Therefore, if a sum of the values of the overlaps ΔCₖ of the grids k is taken according to the number of occupied grids as in Expression (2), it is equal to the number of occupied grids. On the other hand, the lower part of FIG. 8 shows an example of “the case where the distance to the obstacle is less than the threshold value.” In this case, the state of the grid (gray) corresponding to the robot arm 11 and the grid corresponding to the obstacle (black) is the same, i.e., the overlapping grid is indicated by a diagonal line. In the same grid (diagonal line) of the occupied state, the value of the overlap ΔC_{k′} of the grid k of Eq. (3) is 0. Therefore, when the sum of the values of the overlaps ΔC_{k′} of the grids k is taken according to the number of occupied grids, the sum is less than the number of occupied grids, because the number of overlapping grids is 0. From the above, on the basis of the sum of the values of the overlaps ΔC_{k′} of the grid k of Eq. (3), it is possible to determine whether the distance to the obstacle is greater than or equal to the threshold value or less than the threshold value, i.e., whether the robot arm 11 is approaching or entering the obstacle area. Also, the threshold value for the distance to the obstacle depends on the resolution when it is represented by voxels, i.e., a grid size shown in FIG. 8. The larger the grid size, the longer the distance to be the threshold value. On the other hand, the smaller the grid size, the shorter the distance to be the threshold value, and the accuracy of spatial determination is improved. This grid size can be appropriately decided in accordance with the size and operation speed of the robot arm 11, the task to be executed, the processing capability of the determination processing unit 34, and the like. Also, the method of calculating the overlap by representing the overlap in voxels in this way has the advantage of high calculation efficiency because it is an expression based on an octree as in the information comparison unit 35 described above.

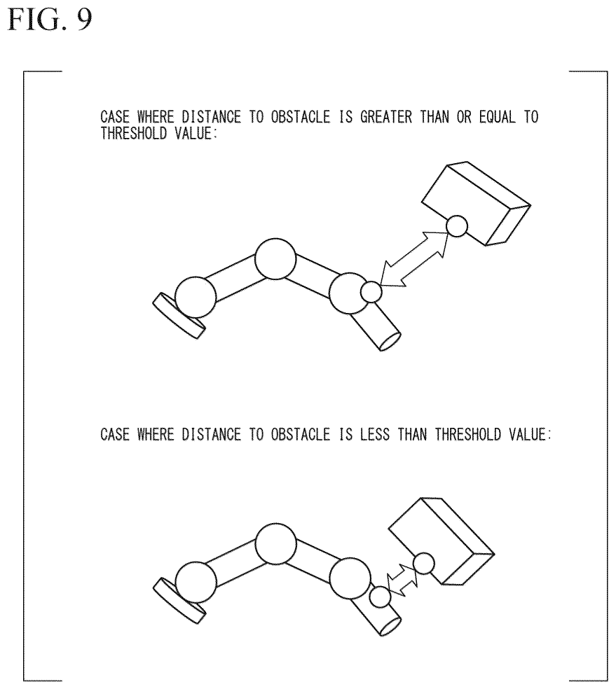

Other specific examples in the first application example will be described with respect to the process of the determination processing unit 34. FIG. 9 is a diagram for describing the process of the determination processing unit 34 according to the first application example. FIG. 9 shows an example of a determination process performed by the determination processing unit 34 according to the nearest distance. The information output by the information generation unit 42 of the virtual environment 4 and the obstacle candidate information output by the information exclusion unit 33 can be represented as an aggregate of three-dimensional position information, for example, an aggregate of points indicating three-dimensional coordinates referred to as point cloud data. In FIG. 9, as in FIG. 8, three-dimensional information indicating the robot arm 11 as information output by the information generation unit 42 and three-dimensional information indicating a cube as an example of obstacle candidate information are shown and the three-dimensional information is represented by a point cloud. Within this point cloud, a point where a Euclidean distance is shortest between the robot arm 11 and the obstacle, a so-called nearest point, is indicated by a black point, and a distance between the nearest points is schematically represented by an arrow. The upper part of FIG. 9 shows an example of “a case where the distance to the obstacle is greater than or equal to the threshold value,” and the nearest distance between the robot arm 11 and the cube is longer as is clear from FIG. 9. On the other hand, a “case where the distance to the obstacle is less than the threshold value” in the lower part of FIG. 9 indicates that the nearest distance between the robot arm 11 and the cube is shorter. Thus, it is possible to determine whether or not the robot arm 11 is approaching or entering the obstacle area by calculating the nearest distance and setting a certain threshold value. In addition, the threshold value can be appropriately determined according to the size and operation speed of the robot arm 11, the task to be executed, the processing capability of the determination processing unit 34, and the like. As a method of finding the nearest point, for example, algorithms such as a nearest neighbor search and a k-neighbor search can be used. The above processing corresponds to the operation of step S105 in the flowchart shown in FIG. 2 or FIG. 4 of the first or second example embodiment. Moreover, the specific processing methods of the two types of determination processing units 34 have been described above, but the present invention is not limited thereto.

The application example when the movable device 1 is a robot arm has been described above. According to the first application example, when the robot arm 11 approaches or enters the obstacle area, an instruction to limit the operation range or operation speed of the robot arm 11 or a stop instruction is given and therefore the work efficiency and safety are high and a process of precisely controlling the controlled unit 11 can be implemented. Although an example in which the movable device 1 includes the robot arm 11 has been described, the present invention can be applied to the movable device 1 including a movable unit 11a, such as another robot, a machine tool, or an assembly machine. In particular, the present invention is suitably applicable to a work machine in which there is a possibility that a movable unit 11a such as an arm will enter an obstacle area. Although the obstacle has been described with an example of a case where the number of cubes is one, the shapes and number of obstacles are not limited.

### Second Application Example

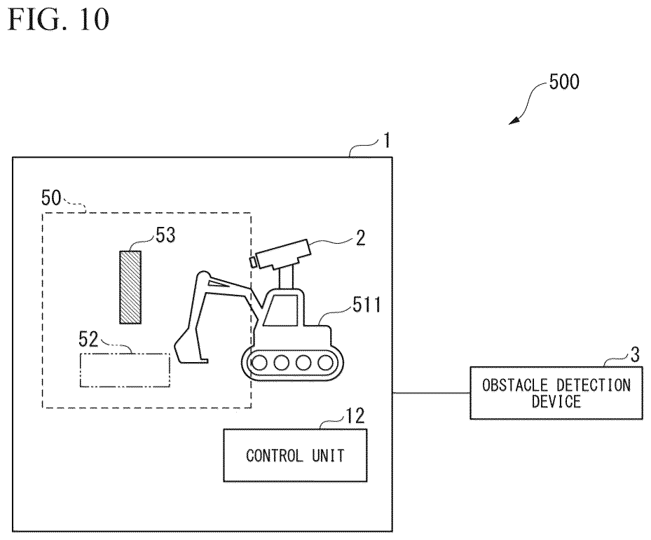

A second application example shows an example of a backhoe when the movable device 1 in the first or second example embodiment is a construction machine. FIG. 10 is a diagram showing an example of a configuration of a control system 500 according to the second application example.

As shown in FIG. 10, the movable device 1 of the second application example includes at least a backhoe 11, a control unit 12 that controls the backhoe 11, and an observation device 2 mounted on the backhoe 11. As in the first application example, the observation device 2 is a device capable of acquiring three-dimensional information such as a depth camera and a LiDAR sensor. Although a configuration mounted on the backhoe 11 is shown as an example, the types, mounting locations, and number of devices are not limited. The obstacle detection device 3 is similar to the obstacle detection device 3 in the first to third example embodiments. Although the configuration of the control system 500 shown in FIG. 10 is a configuration in which the movable device 1 and the obstacle detection device 3 are connected one-to-one, the number of connected devices and configurations of the devices are not limited. For example, the control system 500 may have a configuration including a plurality of movable devices 1, i.e., a plurality of backhoes 11.

The movable device 1 includes at least a controlled unit 11 and a control unit 12 as in the first to third example embodiments. In the second application example, the backhoe 11 is the controlled unit 11 and the controller 12 that controls the backhoe 11 is the control unit 12. Also, the control unit 12 may be included in the movable device 1 or exist in another location connected by a network and a configuration of the control unit 12 and a method of generating the control signal are not limited in the second application example. Moreover, the backhoe 11 may be automatically (autonomously) driven by the control unit 12 or driven by an appearing operator, or the operator may remotely transmit a control signal in place of the control unit 12. A method of controlling or maneuvering the backhoe 11 is not limited. When an obstacle is detected by the obstacle detection device 3 of the second application example while the operator is boarding and driving the backhoe 11, the obstacle detection device 3 may warn the operator with an alert, or may intervene in the operator's operation by a deceleration or stop signal to the control unit 12.

Hereinafter, as an example of a case where the actual work (task) is controlled using the control system 500, the task of excavating soil and sand using the controlled unit 11 of the movable device 1 as the backhoe 11 will be described as an example. In addition, the task content is an example and is not limited to the task content shown in the second application example. In FIG. 10, an example of the observation area 50 observed by the observation device 2 is shown. The observation area 50 includes at least a part of the backhoe 11. The task assumed in the second application example is a task of excavating soil and sand existing in a part of a target area 52 shown in FIG. 10. Here, to excavate the soil and sand in the target area 52, i.e., a part of the backhoe 11, specifically the bucket at the end of the arm, is brought close to the soil and sand in the target area 52, and finally the bucket needs to come into contact with the soil and sand. In other words, the backhoe 11 comes into contact with at least a part of the target area 52, but the target area 52 is not an obstacle area, i.e., it is necessary to allow approach or contact. Therefore, the target area 52 has the same meaning as the target area 52 in the first application example. Although the target area 52 is set as one location in the second application example, the setting method and number of areas of the target area 52 may be set depending on the task and the setting method and number of areas of the target area 52 are not limited. In FIG. 10, an obstacle or obstacle area 53 that the backhoe 11 is not allowed to approach or enter is shown. The obstacle area 53 has the same meaning as the obstacle area 53 of the first application example.

Hereinafter, a method of executing a task of excavating the target area 52 without the backhoe 11 approaching or entering the obstacle area 53 using the obstacle detection device 3 described in the first to third example embodiments will be described. The position/posture data acquisition unit 31 of the obstacle detection device 3 acquires information of each movable unit 11a constituting the backhoe 11 and the observation data acquisition unit 32 acquires three-dimensional information of the observation area 50. Also, when the backhoe 11 is hydraulically controlled and current information of the movable unit 11a cannot be electrically acquired, position/posture data may be acquired by each movable unit 11a or a sensor attached to the housing. The sensor may be, for example, a sensor installed externally such as an inclination sensor, a gyro sensor, an acceleration sensor, or an encoder. The virtual environment 4 constructs a model simulating the three-dimensional shape and movement of the backhoe 11. By executing a process in which the environment setting unit 41 sets the model on the basis of the information acquired by the position/posture data acquisition unit 31, the actual backhoe 11 and the model within the virtual environment 4 are synchronized, i.e., the position and/or posture can be made consistent within a certain specified error range. Moreover, on the basis of a position or posture relationship between the actual backhoe 11 and the observation device 2, a model is set, i.e., calibrated, by the environment setting unit 41 in the virtual environment 4. As a result, among the information items acquired by the observation data acquisition unit 32, the position in the three-dimensional space occupied by the backhoe 11 and the position in the three-dimensional space occupied by the model generated by the information generation unit 42 are consistent within a certain specified error range.

Also, by applying the second example embodiment as the obstacle detection device 3 of the second application example, the information comparison unit 35 can determine the failure of each movable unit 11a or the sensor attached to the housing described above. The operation of the control system 500 can be considered as in the control system 200 according to the second example embodiment.

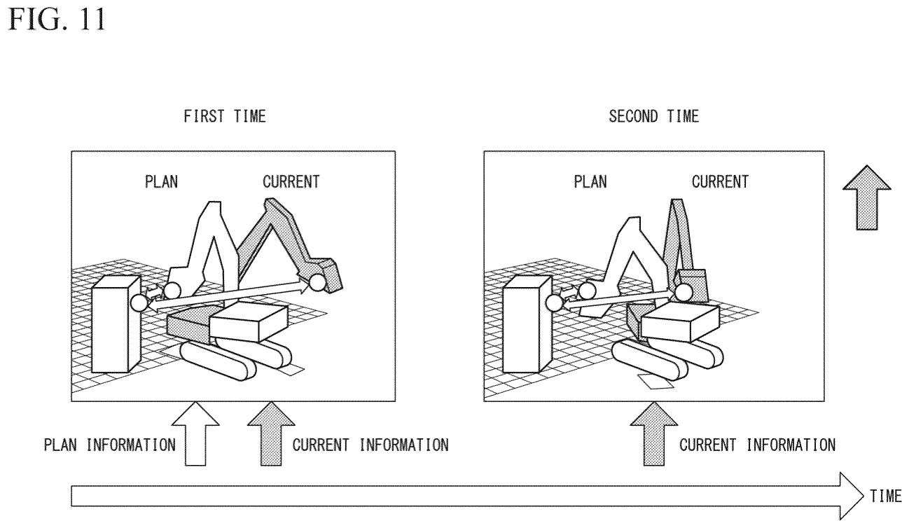

Hereinafter, an example in which the control plan information described in the third example embodiment is used in the second application example will be described with respect to the process of the determination processing unit 34. FIG. 11 is a diagram for describing a process of the determination processing unit 34 according to the second application example. In FIG. 11, the process of the determination processing unit 34 when the obstacle detection device 3 of the third example embodiment including the control plan data acquisition unit 36 is applied is schematically shown. In FIG. 11, two types of models of the virtual environment 4 simulating the actual backhoe 11 are shown. One model is a model in which a position and/or posture are set on the basis of the control plan acquired by the control plan data acquisition unit 36 and the other model is a model in which the current position and/or posture acquired by the position/posture data acquisition unit 31 are reflected. Moreover, in FIG. 11, the shape of a cube is shown as an example of the obstacle area 53. The horizontal axis represents time. In FIG. 11, states of the models at two different times are shown. As an example, the time shown on the left side in FIG. 11 is a first time and the time when a fixed period of time has elapsed from the first time shown on the right side in FIG. 11 is a second time. At the first time, the state of the model is set on the basis of both the plan information and the current information. Also, the plan information is a state after the certain fixed period of time with respect to the current state. That is, in a case where a control process has been performed ideally, when a fixed period of time has elapsed, the current state coincides with the state based on the plan information. FIG. 11 shows a determination method based on the nearest distance described in the first application example as an example of the process of the determination processing unit 34. At the first time, the shape information of the model based on each item of the plan information and the current information and the nearest distance of the cube of the obstacle area 53 included in the obstacle candidate information are indicated by arrows. From FIG. 11, it can be seen that the model based on the plan information is approaching the obstacle area, but the model based on the current state is away from the obstacle area. Here, according to the assumption, it is determined that “the distance to the obstacle area is less than the threshold value (as in the lower part of FIG. 9)” in the determination based on the plan information and it is determined that “the distance to the obstacle area is greater than or equal to the threshold value (the upper part of FIG. 9)” in the determination based on the current information. In this case, for example, an instruction to decelerate the backhoe 11 is output according to determination based on the plan information. In determination based on the current state, the instruction is not output and the control of the backhoe 11 continues. However, the control unit 12 that controls the actual backhoe 11 can receive only one instruction, such that it is necessary to select one of the instructions. The selection of this instruction can be implemented by providing a specified rule (algorithm) in advance. For example, an instruction of the determination based on the plan information is an instruction to “decelerate” because the determination based on the plan information has a more time grace period than the determination based on the current state, while an instruction of the determination based on the current state is an instruction to “stop” because the determination based on the current state has no time grace period as compared with the determination based on the plan information. Thus, when a plurality of determination results are output by applying the obstacle detection device 3 of the third example embodiment, the determination results can be integrated on the basis of a specified rule. Next, at the second time shown in FIG. 11, the control system 500, for example, updates the model on the basis of the current position/posture information without updating the model on the basis of plan information. This is because the plan information is up to a certain objective value or for each fixed sequence and the current information can change from moment to moment if the backhoe 11 is moving toward the objective value. As a result, it can be seen that the position of the backhoe 11 indicated by the model based on the current information is closer to the position of the backhoe 11 indicated by the model based on the plan information at the second time than at the first time. That is, the position of the backhoe 11 indicated in the model based on the current information is also close to the obstacle. Therefore, according to the assumption, it is determined that “the distance to the obstacle area is less than the threshold value” at the second time. Then, at the second time, the approach to the obstacle of the backhoe 11 is detected by both the model based on the plan information and the model based on the current information. Therefore, for example, the control plan data acquisition unit 36 can choose to stop the backhoe 11 from a determination result obtained by integrating a determination result from the model based on the control plan and a determination result from the model based on the current information. The integration of the determination results described above is an example and the integration of the determination results by the control plan data acquisition unit 36 is not limited to stopping the backhoe 11.

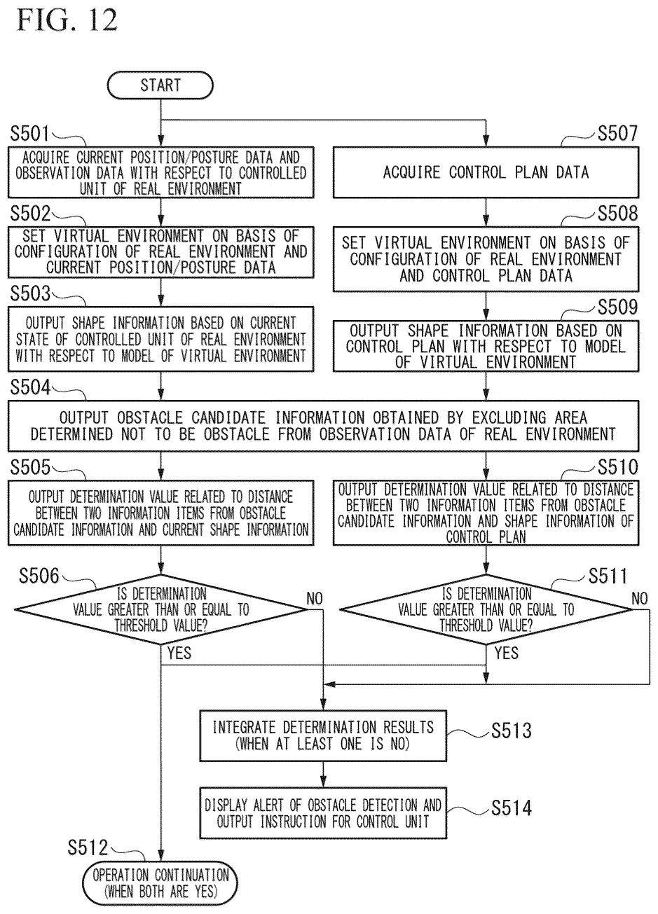

Next, a specific example of the process of the determination processing unit 34 when the above-described control plan information is used will be described with reference to FIG. 12. FIG. 12 is a flowchart related to the process of the determination processing unit 34 according to the second application example. The processing of steps S501 to S506 performed by the determination processing unit 34 on the basis of current position/posture information is similar to the processing of steps S101 to S106 of the first example embodiment shown in FIG. 2. The determination processing unit 34 according to the second application example acquires information of the control plan (step S507). The determination processing unit 34 sets a virtual environment on the basis of the configuration of the real environment and the information of the control plan (step S508). The determination processing unit 34 outputs shape information based on the control plan for the model of the virtual environment (step S509). Here, the processing of step S504 is performed and the determination processing unit 34 outputs a determination value related to a distance between two information items from the obstacle candidate information and the shape information of the control plan (step S510). The determination processing unit 34 determines whether or not the determination value is greater than or equal to the threshold value (step S511).

When the determination value is greater than or equal to the threshold value (step S511; YES), the determination processing unit 34 confirms whether the determination in the processing of step S6 is YES or NO. When the determination in the processing of step S6 is YES, the determination processing unit 34 causes the operation of the movable device 1 to continue (step S512). When the determination in the processing of step S6 is NO, the determination processing unit 34 integrates the determination results (step S513). As described above, for example, the integration can be decided on the basis of a rule specified in advance such as only an alert or a deceleration instruction in the case based on the plan information or a stop instruction in the case based on the current information. This rule can be appropriately decided in consideration of a work environment, the content of a task, the performance of the movable device 1, and the like. Also, the determination processing unit 34 displays an alert and outputs an instruction for the control unit 12 on the basis of the integrated determination result (step S514).

Moreover, when the determination value is less than the threshold value (step S511; NO), the determination processing unit 34 confirms whether the determination in the processing of step S6 is YES or NO. When the determination in the processing of step S6 is YES, the determination processing unit 34 integrates the determination results (step S513). When the determination in the processing of step S6 is NO, the determination processing unit 34 proceeds to the processing of step S13.

The second application example in which the movable device 1 is the construction machine and the controlled unit 11 is the backhoe 11 has been described above. According to the second application example, when the backhoe 11 approaches or enters the obstacle area, it is possible to implement precise control with high work efficiency and safety by issuing an instruction to limit the operation range or operation speed of the backhoe 11 or an instruction to stop. Although the backhoe 11 is shown as an example of the controlled unit 11 provided in the movable device 1, the present invention can be applied to other construction machinery, civil engineering and construction machinery, or the like as long as it is the movable device 1 including the movable unit 11a. In particular, the technology described in the second application example can be preferably applied to a work machine in which the movable unit 11a such as an arm is likely to enter an obstacle area. Although a case where one cubic obstacle exists has been described as an example for the obstacle, the shape and number of obstacles are not limited.

### Third Application Example

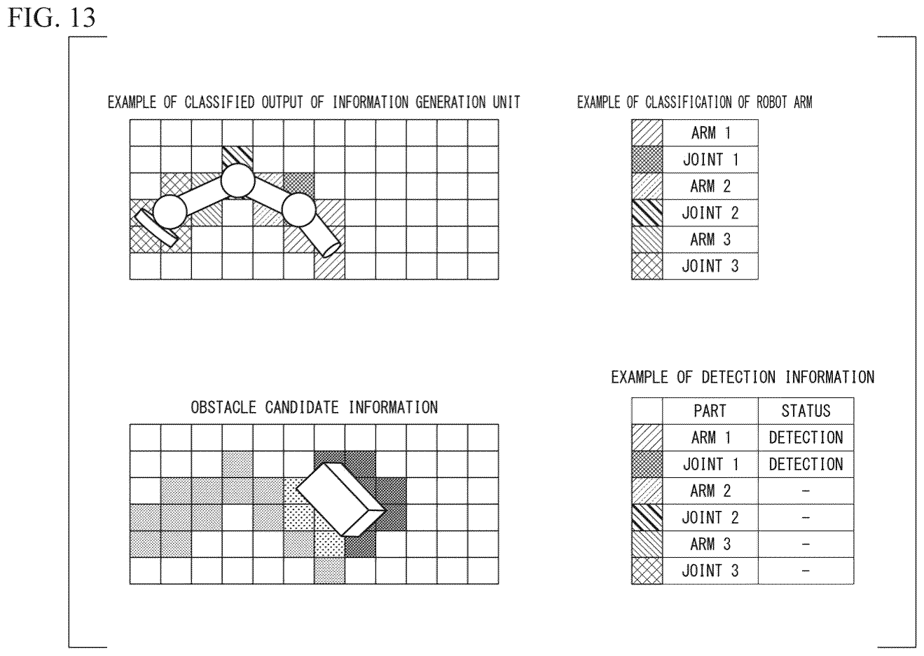

A configuration of the movable device 1 of the third application example is the same as the configuration of the movable device 1 of the first application example. However, in the third application example and the first application example, operations of the information generation unit 42 and the determination processing unit 34 are different. FIG. 13 is a diagram for describing processes of the information generation unit 42 and the determination processing unit 34 according to the third application example. First, the process of the information generation unit 42 will be described. As shown in the upper part of FIG. 13, the information generation unit 42 according to the third application example outputs information classified for each part of the robot arm 11 (arm 1, joint 1, arm 2, joint 2, arm 3, or joint 3), i.e., occupancy information of the three-dimensional space for each part.

In the control system 300 according to the third example embodiment whose configuration is shown in FIG. 5, this process can be performed equivalently to a process in which a plurality of information items are generated on the basis of the current controlled unit 11 and information of control plans at a plurality of different timings. That is, “position information occupied by a plurality of three-dimensional shapes based on a plurality of control plans” in the third example embodiment corresponds to “occupancy information of the three-dimensional space for each part” in the third application example. Also, the classification of the parts for the robot arm 11 described above is an example and the present invention is not limited thereto. Moreover, a similar classification can also be applied to the second application example.

Also, the information generation unit 42 in the first application example outputs information of whether or not the three-dimensional space is occupied by the robot arm 11. That is, in the first application example, all the three-dimensional information indicating the robot arm 11 is of the same classification.

Next, a process of the determination processing unit 34 when the information generation unit 42 outputs the occupancy information of the three-dimensional space for each part will be described. In the lower part of FIG. 13, a processing example of the “case where the distance to the obstacle is less than the threshold value” described in FIG. 8 in the first application example is shown. In the obstacle candidate information, it is assumed that the grid in which the obstacle area overlaps the controlled unit 11 is the same as the grid (dot pattern) in FIG. 8 in the first application example. As described in the first application example, the determination processing unit 34 outputs information of whether or not there is an overlap. On the other hand, in the third application example, as described on the right side of the lower part of FIG. 13, the determination processing unit 34 outputs status information indicating whether or not there is an overlap (there is an overlap: detection or there is no overlap:) for each part of the robot arm 11 that has been classified. In the process in which the determination processing unit 34 outputs the status information, the obstacle candidate information is the same as the obstacle candidate information in the first application example and a plurality of shape information items output by the information generation unit 42 are present for each part. Therefore, in the operation flow shown in FIG. 4, a process in which the determination processing unit 34 outputs the status information can be implemented by iterating a process of outputting a determination value related to a distance between the obstacle candidate information and the shape information from the two information items (step S105) and a process of determining whether or not the determination value is greater than or equal to the threshold value (step S106) by the number of parts or executing the processes for each part in parallel.

As in the movable device 1 of the third application example, an additional effect of detecting the approach of the controlled unit 11 to the obstacle for each part of the controlled unit 11 will be described. In the third application example, information indicating the approach of the controlled unit 11 to an obstacle is output separately for each part of the controlled unit 11. Thereby, it is possible to know which of the plurality of parts of the controlled unit 11 has an inappropriate position and/or posture and it is possible to identify a part approaching the obstacle. Moreover, when the operation of the controlled unit 11 stops due to the approach of the part of the controlled unit 11 to the obstacle, it is possible to determine which part of the controlled unit 11 can be operated to move away from the obstacle. Also, in the first application example and the second application example, only information of whether or not the approach to the obstacle of the controlled unit 11 is detected is output and information about the location of the controlled unit 11 that has approached the obstacle cannot be obtained. Therefore, it cannot be said that there is sufficient information for investigating the cause, such as why the unnecessary approach occurred.

The present invention has been described above with reference to the above-described example embodiments and application examples as examples. However, the present invention is not limited to the above-described content. It is possible to apply the present invention to various forms without departing from the scope and spirit of the present invention. For example, some or all of the functions of each of the movable device 1, the observation device 2, and the obstacle detection device 3 may be provided in a device different from the own device. Also, in this case, the device including the determination processing unit 34 becomes a processing device.

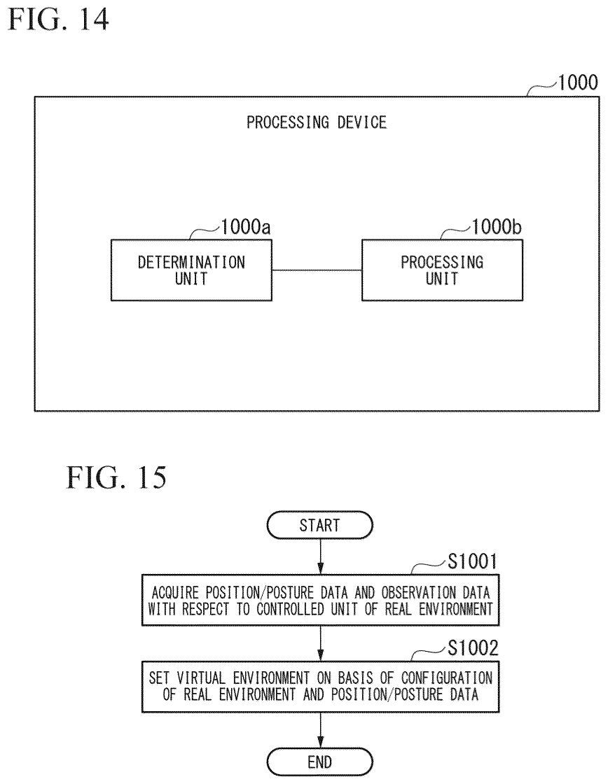

FIG. 14 is a diagram showing a minimum configuration of the processing device 1000 according to the example embodiment. As shown in FIG. 14, the processing device 1000 includes a determination unit 1000a (an example of determination means) and a processing unit 1000b (an example of a processing means). The determination unit 1000a determines whether or not the control target has entered an area other than the area that the control target is allowed to enter in an environment including at least a part of the control target including a movable unit. When the determination unit determines that the control target has entered an area other than the area that the control target is allowed to enter, the processing unit 1000b executes a predetermined process. Examples of the predetermined process include notifying that the control target has entered an area other than the area that the control target is allowed to enter.

Next, a process of the processing device 1000 having the minimum configuration according to the example embodiment will be described. Here, a processing flow shown in FIG. 15 will be described.

The determination unit 1000a determines whether or not the control target has entered an area other than the area that the control target is allowed to enter in an environment including at least a part of the control target including the movable unit (step S1001). When the determination unit determines that the control target has entered an area other than the area that the control target is allowed to enter, the processing unit 1000b executes a predetermined process (step S1002).

The processing device 1000 having the minimum configuration according to the example embodiment of the present invention has been described above. This processing device 1000 can implement a process of precisely controlling the control target.

Also, in the process in the example embodiment of the present invention, the order of processing may be swapped in a range in which the appropriate process is performed.

Although example embodiments of the present invention have been described, the control systems 100, 200, 300, 400, and 500, the movable device 1, the observation device 2, and the obstacle detection device 3 described above and other control devices may internally include a computer system. The process of the above-described processing is stored on a computer-readable recording medium in the form of a program, and the above process is performed by the computer reading and executing the program. A specific example of the computer is shown below.

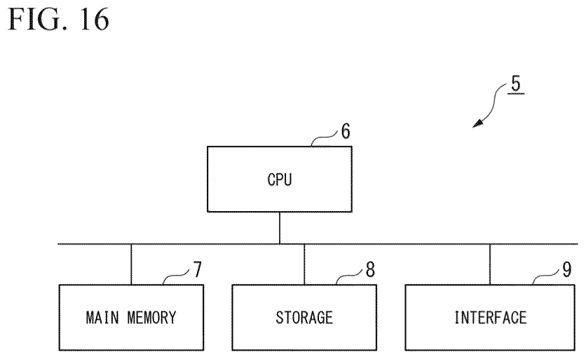

FIG. 16 is a schematic block diagram showing a configuration of a computer according to at least one example embodiment. As shown in FIG. 16, a computer 5 includes a CPU 6, a main memory 7, a storage 8, and an interface 9. For example, each of the control systems 100, 200, 300, 400, and 500, the movable device 1, the observation device 2, and the obstacle detection device 3 described above and the other control devices is implemented in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read only memory (CD-ROM), a digital versatile disc read only memory (DVD-ROM), a semiconductor memory, and the like. The storage 8 may be an internal medium directly connected to a bus of the computer 5 or an external medium connected to the computer 5 via the interface 9 or a communication line. Also, when the above program is distributed to the computer 5 via a communication line, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer system, a so-called differential file (differential program).

While some example embodiments of the present invention have been described, the example embodiments are examples and do not limit the scope of the invention. Various additions, omissions, substitutions, and modifications can be made without departing from the spirit or scope of the present invention.

### INDUSTRIAL APPLICABILITY

In the processing device, processing method, and program according to the present invention and the like, a process of precisely controlling a control target can be implemented.

### REFERENCE SIGNS LIST

1 Movable device
2 Observation device
3 Obstacle detection device
4 Virtual environment
5 Computer
6 CPU
7 Main memory
8 Storage
9 Interface
11 Controlled unit, robot arm, backhoe
11a Movable unit
12 Control unit
31 Position/posture data acquisition unit
32 Observation data acquisition unit
33 Information exclusion unit
34 Determination processing unit
35 Information comparison unit
41 Environment setting unit
42 Information generation unit
50 Observation area
51 Target object
52 Target area
53 Obstacle area
100, 200, 300, 400, 500 Control system
1000 Processing device
1000a Determination unit
1000b Processing unit

What is claimed is:

1. A processing device comprising:
a memory configured to store instructions; and
a processor configured to execute the instructions to:
determine whether or not a control target has entered an area other than an area that the control target is allowed to enter in an environment of a range including at least a part of the control target; and
execute a predetermined process when it is determined that the control target has entered an area other than the area that the control target is allowed to enter.

2. The processing device according to claim 1, wherein the processor is configured to execute the instructions to:
notify that the control target has entered an area other than the area that the control target is allowed to enter when it is determined that the control target has entered an area other than the area that the control target is allowed to enter.

3. The processing device according to claim 1, wherein the processor is configured to execute the instructions to:
output an instruction to restrict an operation of the control target or stop the operation of the control target to a controller for controlling the control target when it is determined that the control target has entered an area other than the area that the control target is allowed to enter.

4. The processing device according to claim 1, wherein the processor is configured to execute the instructions to:
determine whether or not the control target has entered an area other than the area that the control target is allowed to enter on the basis of an actual measured value pertaining to the control target and an estimated value based on a model simulating the control target.

5. The processing device according to claim 1, wherein the processor is configured to execute the instructions to:
exclude information of the area that the control target is allowed to enter from information of a range including at least a part of the control target; and
determine whether or not the control target has entered an area other than the area that the control target is allowed to enter on the basis of information after the information is excluded.

6. A processing method comprising:
determining whether or not a control target has entered an area other than an area that the control target is allowed to enter in an environment of a range including at least a part of the control target; and
executing a predetermined process when it is determined that the control target has entered an area other than the area that the control target is allowed to enter.

7. A non-transitory computer-readable recording medium storing a program which causes a computer to execute:
determining whether or not a control target has entered an area other than an area that the control target is allowed to enter in an environment of a range including at least a part of the control target; and
executing a predetermined process when it is determined that the control target has entered an area other than the area that the control target is allowed to enter.
